(19) United States
(12) Patent Application Publication
(10) Pub. No.: US 2020/0139676 A1
(43) Pub. Date: May 7, 2020

(54) HEAT RAY-SCREENING MATERIAL, INTERLAYER FOR LAMINATED GLASS, AND LAMINATED GLASS

(71) Applicant: FUJIFILM Corporation, Tokyo (JP)

(72) Inventors: Takehiro KASAHARA, Shizuoka (JP); Hideki YASUDA, Shizuoka (JP); Motoi HARADA, Shizuoka (JP)

(73) Assignee: FUJIFILM Corporation, Tokyo (JP)

(21) Appl. No.: 16/726,217

(22) Filed: Dec. 23, 2019

Related U.S. Application Data
(63) Continuation of application No. PCT/JP2018/020841, filed on May 30, 2018.

(30) Foreign Application Priority Data
Jun. 30, 2017 (JP) 2017-129437

(51) Int. Cl. B32B 15/01; B32B 5/16; G02B 5/22; G02B 5/26

(52) U.S. Cl. CPC B32B 15/01; G02B 5/26; G02B 5/226; B32B 5/16

(57) ABSTRACT

Provided are a heat ray-screening material and an interlayer for laminated glass and laminated glass which have the heat ray-screening material. A first embodiment of the heat ray-screening material has at least a metal flat plate particle-containing layer A containing metal flat plate particles a having an aspect ratio equal to or higher than 10 and equal to or lower than 20. A second embodiment of the heat ray-screening material has at least a metal flat plate particle-containing layer A containing metal flat plate particles a and a metal flat plate particle-containing layer B containing metal flat plate particles b, in which an absolute value of a difference between a maximum reflection wavelength of the metal flat plate particle-containing layer A and a maximum reflection wavelength of the metal flat plate particle-containing layer B is equal to or higher than 220 nm.

### CROSS-REFERENCE TO RELATED APPLICATIONS

This application is a continuation application of International Application No. PCT/JP2018/020841, filed May 30, 2018, the disclosure of which is incorporated herein by reference in its entirety. Further, this application claims priority from Japanese Patent Application No. 2017-129437, filed Jun. 30, 2017, the disclosure of which is incorporated herein by reference in its entirety.

### BACKGROUND OF THE INVENTION

### 1. Field of the Invention

The present disclosure relates to a heat ray-screening material, an interlayer for laminated glass, and laminated glass.

### 2. Description of the Related Art

In recent years, as one of the energy saving policies for carbon dioxide reduction, the materials adding heat ray-screening properties to windows of automobiles or buildings have been developed.

Conventionally, these heat ray-screening materials are mainly installed on the inside of windows (so-called inside pasting). However, in recent years, the heat ray-screening materials have been required to be installed in a place where it is difficult to install a scaffolding in a room, a place where an immovable object is in a room, or a place where the indoor environment is under dew condensation conditions all the time or under extreme temperature conditions (so-called outside pasting). Furthermore, from the viewpoint of heat ray-screening properties, in order to inhibit the light absorbed into the inside of a window from being radiated again, to inhibit the light reflected from the inside of a window from being reflected again from the window glass into a room, and the like, it is required for the light to be absorbed into or reflected from the outside of a window. In addition, from the viewpoint of heat ray-screening properties (solar heat gain rate), compared to a heat ray-absorbing type which allows the absorbed light to be radiated again (approximately ⅓ of the absorbed solar radiation energy is radiated again), a heat ray-reflecting type inhibiting re-radiation is more desirable, and various materials of this type have been suggested.

JP2011-253093A describes a heat ray-screening material having at least two metal particle-containing layers containing at least one kind of metal particles and at least one transparent dielectric layer, in which the metal particle-containing layers and the dielectric layer are alternately laminated, and an optical thickness (nd) of at least one layer constituting the dielectric layer satisfies Formula (1) for a wavelength λ1 at which a reflectance is minimized.

{(2m+1)×(λ1/4)}−{(λ1/4)×0.25}<nd<{(2m+1)×(λ1/4)}+{(λ1/4)×0.25} (1)

Here, m represents an integer equal to or greater than 0, 21 represents a wavelength at which a reflectance is minimized, n represents a refractive index of the dielectric layer, and d represents a thickness (nm) of the dielectric layer.

JP2013-205810A describes an infrared-screening film having at least a metal particle-containing layers containing at least one kind of metal particles, in which a proportion of metal flat plate particles in the metal particles is equal to or higher than 60% by number, and at one of the metal particle-containing layers has at least two absorption peaks or at least two reflection peaks at 800 to 2,000 nm.

### SUMMARY OF THE INVENTION

An object of an embodiment of the present invention is to provide a heat ray-screening material having excellent heat blocking performance.

An object of another embodiment of the present invention is to provide an interlayer for laminated glass and laminated glass which comprise a heat ray-screening material having excellent heat blocking performance.

Specific means for achieving the above objects includes the following aspects.
<1> A heat ray-screening material having at least a metal flat plate particle-containing layer A which contains metal flat plate particles a having an aspect ratio equal to or higher than 10 and equal to or lower than 20 and a metal flat plate particle-containing layer B which contains metal flat plate particles b having an aspect ratio higher than 20 and equal to or lower than 60.
<2> The heat ray-screening material described in <1> further having at least one transparent dielectric layer between the metal flat plate particle-containing layer A and the metal flat plate particle-containing layer B.
<3> The heat ray-screening material described in <2>, in which an optical thickness nd of the dielectric layer satisfies Formula 1 for a wavelength λ1 at which a reflectance is minimized.

{(2m+1)×(λ1/4)}−{(λ1/4)×0.20}<nd<{(2m+1)×(λ1/4)}+{(λ1/4)×0.20} Formula (1)

Here, m represents an integer equal to or greater than 0, λ1 represents a wavelength at which a reflectance is minimized, n represents a refractive index of the dielectric layer, d represents a thickness of the dielectric layer, and the unit of λ1 and d is nm.
<4> The heat ray-screening material described in <3>, in which m in Formula 1 is 0 or 1.
<5> The heat ray-screening material described in <4>, in which in a case where m is 0, the metal flat plate particle-containing layer B is disposed to be closer to a solar radiation incoming direction than the metal flat plate particle-containing layer A is, and in a case where m is 1, the metal flat plate particle-containing layer A is disposed to be closer to the solar radiation incoming direction than the metal flat plate particle-containing layer B is.
<6> The heat ray-screening material described in any one of <1> to <5>, in which each of the metal flat plate particles a and the metal flat plate particles b contains at least silver.
<7> The heat ray-screening material described in any one of <1> to <6> further having an ultraviolet absorbing layer.
<8> The heat ray-screening material described in <7>, in which the ultraviolet absorbing layer is closer to the solar radiation incoming direction than the metal flat plate particle-containing layer A and the metal flat plate particle-containing layer B are.
<9> The heat ray-screening material described in any one of <1> to <8>, in which the aspect ratio of the metal flat plate particles b is equal to or higher than 30 and equal to or lower than 60.
<10> The heat ray-screening material described in any one of <1> to <9>, in which a value of the aspect ratio of the metal flat plate particles b/the aspect ratio of the metal flat plate particles a is equal to or higher than 2 and equal to or lower than 6.
<11> An interlayer for laminated glass including the heat ray-screening material described in any one of <1> to <10>.
<12> Laminated glass having the interlayer for laminated glass described in <11> and at least two sheets of glass plates, in which the interlayer for laminated glass is between two sheets of the glass plates.
<13> A heat ray-screening material having at least a metal flat plate particle-containing layer A containing metal flat plate particles a and a metal flat plate particle-containing layer B containing metal flat plate particles b, in which an absolute value of a difference between a maximum reflection wavelength of the metal flat plate particle-containing layer A and a maximum reflection wavelength of the metal flat plate particle-containing layer B is equal to or higher than 220 nm.

According to an embodiment of the present invention, a heat ray-screening material having excellent heat blocking performance can be provided.

Furthermore, according to another embodiment of the present invention, it is possible to provide an interlayer for laminated glass and laminated glass which comprise a heat ray-screening material having excellent heat blocking performance.

### BRIEF DESCRIPTION OF THE DRAWINGS

FIG. 1 is a schematic perspective view showing an example of a silver flat plate nanoparticle used in the present disclosure.

FIG. 2 is a schematic perspective view showing another example of the silver flat plate nanoparticle used in the present disclosure.

FIG. 3 is a schematic cross-sectional view showing an example of a heat ray-screening material according to the present disclosure.

FIG. 4 is a schematic cross-sectional view showing an example of an interlayer for laminated glass according to the present disclosure.

FIG. 5 is a schematic cross-sectional view showing an example of laminated glass according to the present disclosure.

FIG. 6 is a schematic cross-sectional view showing another example of the laminated glass according to the present disclosure.

FIG. 7 is a schematic cross-sectional view showing still another example of the laminated glass according to the present disclosure.

FIG. 8 is a view showing a transmission spectrum of green glass used in examples.

### DESCRIPTION OF THE PREFERRED EMBODIMENTS

Hereinafter, the present disclosure will be specifically described.

In the present specification, a description of “xx to yy” represents a range of numerical values including xx and yy.

Furthermore, in the present specification, the term “step” includes not only an independent step but also a step which is not clearly differentiated from other steps as long as the object of the step is accomplished as intended.

In the present disclosure, unless otherwise specified, hydrocarbon groups such as an alkyl group, an aryl group, an alkylene group, and an arylene group may have a branch or a ring structure.

Furthermore, in the present disclosure, “% by mass” has the same definition as “% by weight”, and “part by mass” has the same definition as “part by weight”.

In the present disclosure, a combination of two or more preferred aspects is a more preferred aspect.

In addition, in the present disclosure, unless otherwise specified, each of the weight-average molecular weight (Mw) and the number-average molecular weight (Mn) is a molecular weight which is detected using a gel permeation chromatography (GPC) analysis device using TSKgel GMHxL, TSKgel G4000HxL, and TSKgel G2000HxL (trade name, manufactured by Tosoh Corporation) as columns, tetrahydrofuran (THF) as a solvent, and a differential refractometer and expressed in terms of polystyrene as a standard substance.

(Heat Ray-Screening Material)

A first embodiment of a heat ray-screening material according to the present disclosure has at least a metal flat plate particle-containing layer A which contains metal flat plate particles a having an aspect ratio equal to or higher than 10 and equal to or lower than 20 and a metal flat plate particle-containing layer B which contains metal flat plate particles b having an aspect ratio higher than 20 and equal to or lower than 60.

A second embodiment of the heat ray-screening material according to the present disclosure has at least a metal flat plate particle-containing layer A containing metal flat plate particles a and a metal flat plate particle-containing layer B containing metal flat plate particles b, in which an absolute value of a difference between a maximum reflection wavelength of the metal flat plate particle-containing layer A and a maximum reflection wavelength of the metal flat plate particle-containing layer B is equal to or higher than 220 nm.

Hereinafter, unless otherwise specified, “heat ray-screening material according to the present disclosure” refers to both the first embodiment and second embodiment of the heat ray-screening material according to the present disclosure.

The conventional heat ray-screening materials containing metal flat plate particles are still unsatisfactory in terms of the heat blocking performance. For example, although JP2011-253093A suggests a method of arranging metal particles in two layers with a dielectric layer having a certain thickness interposed therebetween so as to obtain a visible light transmittance and heat blocking performance that are higher than those obtained from a heat ray-screening material constituted with single layer, the heat blocking performance obtained by this method is still unsatisfactory.

As a result of conducting thorough examinations, the inventors of the present invention have found that in a case where a heat ray-screening material is provided with a metal flat plate particle-containing layer A which contains metal flat plate particles a having an aspect ratio equal to or higher than 10 and equal to or lower than 20 and a metal flat plate particle-containing layer B which contains metal flat plate particles b having an aspect ratio higher than 20 and equal to or lower than 60, or in a case where a heat ray-screening material has at least a metal flat plate particle-containing layer A containing metal flat plate particles a and a metal flat plate particle-containing layer B containing metal flat plate particles b and an absolute value of a difference between a maximum reflection wavelength of the metal flat plate particle-containing layer A and a maximum reflection wavelength of the metal flat plate particle-containing layer B is equal to or higher than 220 nm, a heat ray-screening material having excellent heat blocking performance is obtained.

The detailed mechanism thereof is unclear but is assumed to be as below.

Presumably, in a case where a heat ray-screening material is provided with the metal flat plate particle-containing layers A and B which each contain metal flat plate particles having a specific aspect ratio described above, and light transmitted through a first layer is reflected from a second layer, in the metal flat plate particle-containing layers A and B, unlike in layers containing metal flat plate particles having the same aspect ratio in which the light reflected from the second layer is reflected again from the back surface of the first layer, the light reflected from the second layer may be transmitted through the first layer without being reflected from a back surface of the first layer, and accordingly, the reflection efficiency of light may increase, and the heat blocking performance may be improved.

Furthermore, the inventors of the present invention presume that because the metal flat plate particles each having a specific aspect ratio are used or because the heat ray-screening material has the metal flat plate particle-containing layers A and B each having a specific maximum reflection wavelength, a plasmon resonance wavelength may varies between the metal flat plate particle a contained in the metal flat plate particle-containing layer A and the metal flat plate particle b contained in the metal flat plate particle-containing layer B, and accordingly, the phenomenon described above may occur.

<Metal Flat Plate Particle-Containing Layer A and Metal Flat Plate Particle-Containing Layer B>

The first embodiment of the heat ray-screening material according to the present disclosure has at least the metal flat plate particle-containing layer A which contains the metal flat plate particles a having an aspect ratio equal to or higher than 10 and equal to or lower than 20 and the metal flat plate particle-containing layer B which contains the metal flat plate particles b having an aspect ratio higher than 20 and equal to or lower than 60.

Furthermore, in the second embodiment of the heat ray-screening material according to the present disclosure, the aspect ratio of the metal flat plate particles a is preferably equal to or higher than 10 and equal to or lower than 20, and the aspect ratio of the metal flat plate particles b is preferably higher than 20 and equal to or lower than 60.

From the viewpoint of heat blocking performance, it is preferable that the heat ray-screening material according to the present disclosure has the metal flat plate particle-containing layer B on the side of a solar radiation incoming direction and the metal flat plate particle-containing layer B on the side on which solar radiation is not incident.

From the viewpoint of heat blocking performance, the maximum reflection wavelength of the metal flat plate particle-containing layer A is preferably equal to or longer than 500 nm and equal to or shorter than 1,500 nm, more preferably equal to or longer than 700 nm and equal to or shorter than 1,300 nm, and even more preferably equal to or longer than 800 nm and equal to or shorter than 1,200 nm.

From the viewpoint of heat blocking performance, the maximum reflection wavelength of the metal flat plate particle-containing layer B is preferably equal to or longer than 1,000 nm and equal to or shorter than 2,100 nm, more preferably equal to or longer than 1,200 nm and equal to or shorter than 2,000 nm, and even more preferably equal to or longer than 1,400 nm and equal to or shorter than 2,000 nm.

In the second embodiment of the heat ray-screening material according to the present disclosure, the absolute value of the difference between the maximum reflection wavelength of the metal flat plate particle-containing layer A and the maximum reflection wavelength of the metal flat plate particle-containing layer B is equal to or higher than 220 nm. From the viewpoint of heat blocking performance, the absolute value of the difference is preferably equal to or higher than 300 nm, and more preferably equal to or higher than 400 nm and equal to or lower than 1,300 nm.

In the first embodiment of the heat ray-screening material according to the present disclosure, from the viewpoint of heat blocking performance, the absolute value of the difference between the maximum reflection wavelength of the metal flat plate particle-containing layer A and the maximum reflection wavelength of the metal flat plate particle-containing layer B is preferably equal to or higher than 220 nm, more preferably equal to or greater than 300 nm, and even more preferably equal to or higher than 400 nm and equal to or lower than 1,300 nm.

The maximum reflection wavelength of the metal flat plate particle-containing layer A and the metal flat plate particle-containing layer B is measured within a range of 300 nm to 2,100 nm by the method described in JIS R3106:1998 “Testing Method on Transmittance Reflectance and Emittance of Flat Glasses and Evaluation of Solar Heat Gain Coefficient”. From an optical reflection spectrum obtained from the measurement result, a wavelength for maximum reflection is determined and adopted as a maximum reflection wavelength.

The heat ray-screening material according to the present disclosure may have another metal flat plate particle-containing layer in addition to the metal flat plate particle-containing layer A and the metal flat plate particle-containing layer B. However, it is preferable that the heat ray-screening material has only the metal flat plate particle-containing layer A and the metal flat plate particle-containing layer B as metal flat plate particle-containing layers.

In the present specification, a description of “metal flat plate particle-containing layer” means all the metal flat plate particle-containing layers including both the metal flat plate particle-containing layer A and metal flat plate particle-containing layer B that the heat ray-screening material according to the present disclosure has. Furthermore, a description of “metal flat plate particles” means all the metal flat plate particles including both the metal flat plate particles a and metal flat plate particles b.

It is preferable that the metal flat plate particle-containing layer contains at least the metal flat plate particles and additionally contains a binder.

—Metal Flat Plate Particles—

In the first embodiment of the heat ray-screening material according to the present disclosure, the aspect ratio of the metal flat plate particles a contained in the metal flat plate particle-containing layer A is equal to or higher than 10 and equal to or lower than 20. From the viewpoint of heat blocking performance, the aspect ratio is preferably equal to or higher than 12 and equal to or lower than 18, more preferably equal to or higher than 13 and equal to or lower than 17, and even more preferably equal to or higher than 13.5 and equal to or lower than 16.0.

In the second embodiment of the heat ray-screening material according to the present disclosure, from the viewpoint of heat blocking performance, the aspect ratio of the metal flat plate particles a contained in the metal flat plate particle-containing layer A is preferably equal to or higher than 10 and equal to or lower than 20, more preferably equal to or higher than 12 and equal to or lower than 18, even more preferably equal to or higher than 13 and equal to or lower than 17, and particularly preferably equal to or higher than 13.5 and equal to or lower than 16.0.

In the first embodiment of the heat ray-screening material according to the present disclosure, the aspect ratio of the metal flat plate particles b contained in the metal flat plate particle-containing layer B is higher than 20 and equal to or lower than 60. From the viewpoint of heat blocking performance, the aspect ratio is preferably equal to or higher than 25 and equal to or lower than 60, more preferably equal to or higher than 30 and equal to or lower than 60, and even more preferably equal to or higher than 35 and equal to or lower than 60.

In the second embodiment of the heat ray-screening material according to the present disclosure, from the viewpoint of heat blocking performance, the aspect ratio of the metal flat plate particles b contained in the metal flat plate particle-containing layer B is preferably higher than 20 and equal to or lower than 60, more preferably equal to or higher than 25 and equal to or lower than 60, even more preferably equal to or higher than 30 and equal to or lower than 60, and particularly preferably equal to or higher than 35 and equal to or lower than 60.

Furthermore, from the viewpoint of heat blocking performance, a value of the aspect ratio of the metal flat plate particles b/the aspect ratio of the metal flat plate particles a is preferably equal to or higher than 1.2 and equal to or lower than 6, more preferably equal to or higher than 1.5 and equal to or lower than 6, even more preferably equal to or higher than 2 and equal to or lower than 6, and particularly preferably equal to or higher than 2.5 and equal to or lower than 5.

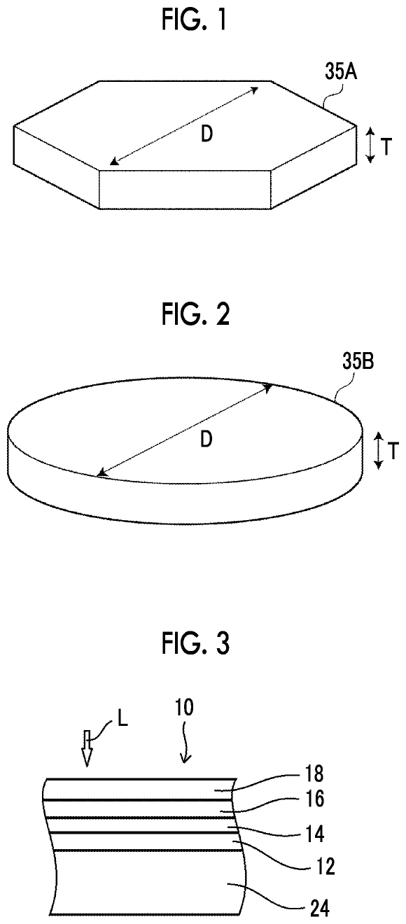

In the present specification, the aspect ratio of metal flat plate particles means a value obtained by dividing an average diameter (corresponding to an average equivalent circular diameter or an average particle diameter), which is determined by approximating a flat area of the metal flat plate particles to circles having the same area, by the average thickness of the metal flat plate particle. The thickness of each of the metal flat plate particles is equivalent to a distance between flat plate surfaces. Specifically, for example, in a case where a metal flat plate particle is in the form of a hexagon, as shown in FIG. 1, the aspect ratio is a value (D/T) obtained by dividing a diameter D (equivalent circular diameter D), which is determined by approximating a flat area of the hexagonal metal flat plate particle to a circle having the same area, by a thickness T. In a case where a metal flat plate particle is in the form of a circle, the aspect ratio is a value (D/T) obtained by dividing the diameter D by the thickness T shown in FIG. 2.

The average equivalent circular diameter of the metal flat plate particle is not particularly limited, and can be appropriately selected according to the purpose. The average equivalent circular diameter of the metal flat plate particles is preferably 10 nm to 500 nm, more preferably 20 nm to 400 nm, and even more preferably 50 nm to 300 nm.

The equivalent circular diameter D of the metal flat plate particles is expressed as a diameter of circles having an area equivalent to a projected area of each of the particles. The projected area of each of the particles can be obtained by a known method of measuring the area in an electron micrograph and correcting the area by the magnification of imaging. Furthermore, an average equivalent circular diameter D_{AV} is determined by statistically obtaining a particle diameter distribution (particle size distribution) of the equivalent circular diameter D of 200 metal flat plate particles and calculating the arithmetic mean from the particle diameter distribution.

The average thickness of the metal flat plate particles is preferably equal to or smaller than 20 nm, more preferably 2 nm to 15 nm, and particularly preferably 4 nm to 12 nm.

The thickness of the metal flat plate particles can be measured using an atomic force microscope (AFM) or a transmission electron microscope (TEM).

Examples of the method for measuring the average thickness by using AFM include a method of adding dropwise a particle dispersion liquid containing metal flat plate particles to a glass substrate, drying the dispersion liquid, measuring thicknesses of the particles, and calculating the average thickness of 200 particles, and the like.

Examples of the method for measuring the average thickness by using TEM include a method of adding dropwise a particle dispersion liquid containing metal flat plate particles to a silicon substrate, drying the dispersion liquid, then performing a coating treatment by means of carbon vapor deposition or metal vapor deposition, making a cross-sectional slice by performing focused ion beam (FIB) processing, measuring the thickness of the particles by observing the cross section with TEM, and calculating the average thickness of 200 particles (hereinafter, described as FIB-TEM as well), and the like.

The material of the metal flat plate particles is not particularly limited, and examples thereof include silver, aluminum, magnesium, tin, gold, copper, and the like.

From the viewpoint of light fastness, visible ray transmission properties, and heat blocking performance, each of the metal flat plate particles a and the metal flat plate particles b preferably contains at least silver and is more preferably a silver flat plate nanoparticle.

As the metal flat plate particles, it is possible to use the near infrared-screening materials described in paragraphs “0019” to “0046” in JP2013-228694A, JP2013-083974A, JP2013-080222A, JP2013-080221A, JP2013-077007A, JP2013-068945A, and the like. What is described in these documents is incorporated into the present specification.

Specifically, the proportion of metal flat plate particles, which are in the form of a polygon having three or more straight sides or in the form of a circle, in the metal flat plate particles is preferably equal to or higher than 60% by number, and a main flat surface of each of the flat plate-like metal particles in the form of a polygon or a circle is preferably planarly oriented while forming an angle of 0° to ±30° on average with one surface of the near infrared-screening layer. The metal flat plate particles are more preferably in the form of a polygon having six or more straight sides.

From the viewpoint of heat blocking performance and visible ray transmission properties, the content of the metal flat plate particles in the metal flat plate particle-containing layer is preferably 0.01 g/m² to 0.2 g/m², more preferably 0.03 g/m² to 0.1 g/m², and even more preferably 0.04 g/m² to 0.08 g/m².

Furthermore, from the viewpoint of heat blocking performance and visible ray transmission properties, the areal density of the metal flat plate particles in the metal flat plate particle-containing layer is preferably 20% by area to 80% by area, and more preferably 30% by area to 70% by area.

In the present specification, the areal density of the metal flat plate particles in the metal flat plate particle-containing layer is a ratio [(B/A)×100] of a total area B of the metal flat plate particles to an area A of the metal flat plate particle-containing layer that is determined in a case where the heat ray-screening material is seen from the surface side thereof.

The areal density can be measured by performing image processing, for example, on an image obtained by observing the substrate of the heat ray-screening material from above by using a scanning electron microscope (SEM) or an atomic force microscope (AFM).

From the viewpoint of heat blocking performance and visible ray transmission properties, it is preferable that the metal flat plate particles contain a metal more precious than silver. “Metal more precious than silver” means “metal having a standard electrode potential higher than a standard electrode potential of silver”.

In the metal flat plate particles, the ratio of the metal, which is more precious than silver, to silver is preferably 0.01 at % to 5 at %, more preferably 0.1 at % to 2 at %, and even more preferably 0.2 at % to 0.5 at %.

The content of the metal more precious than silver can be measured, for example, by dissolving a sample in an acid and the like and then performing high-frequency inductively coupled plasma (ICP) emission spectroscopy.

Each of the metal flat plate particles contains the metal more precious than silver in the vicinity of the surface of the metal flat plate particle. Because the metal flat plate particle contains the metal more precious than silver in the vicinity of the surface of the metal flat plate particle, it is possible to prevent ionization (oxidation) of silver caused by a moist and hot environment and to inhibit the deterioration of a near infrared transmittance.

The vicinity of the surface of the metal flat plate particle includes a region ranging from the surface of the metal flat plate particle to the second to fourth atomic layers from the surface, and the same is true in a case where the surface of the metal flat plate particle is coated with the metal more precious than silver.

Whether the metal more precious than silver is present in the vicinity of the surface of the metal flat plate particle and the content of the metal can be detected, for example, by Auger electron spectroscopy (AES), X-ray photoelectron spectroscopy (XPS), and the like.

Examples of the metal more precious than silver include gold, palladium, iridium, platinum, osmium, and the like. One kind of each of these may be used singly, or two or more kinds of these may be used in combination. Among these, in view of ease of availability of raw materials, palladium, gold, and platinum are particularly preferable.

By performing photoreduction, addition of a reducing agent, or chemical reduction after the formation of the metal flat plate particles, the metal more precious than silver can be incorporated into the vicinity of the surface of the metal flat plate particles. It is preferable that the metal more precious than silver is generated through reduction by silver.

In a case where a reducing agent and a precious metal are simultaneously added, the precious metal is directly reduced, and accordingly, the effect of reduction weakens. Therefore, a method of substituting the precious metal with silver is preferable.

For example, by heating the metal flat plate particles such as silver flat plate nanoparticles in a solvent containing the metal more precious than silver, reduction can be accomplished. By heating the solvent, a metal other than silver is reduced by silver.

Furthermore, according to the purpose, photoreduction, the addition of a reducing agent, a chemical reduction method, and the like may be combined as appropriate.

It is preferable that the reduction is performed in the presence of a complexing agent by which a reduction potential of the formed complex with a gold ion becomes equal to or lower than 0.5 V.

Examples of the complexing agent include a cyan salt (sodium cyanide, potassium cyanide, ammonium cyanide, and the like), thiosulfuric acid, thiosulfate (sodium thiosulfate, potassium thiosulfate, ammonium thiosulfate, and the like), sulfite (sodium sulfite, potassium sulfite, ammonium sulfite, and the like), thiourea, and the like. Among these, from the viewpoint of complex stability and environmental load, sodium sulfite or sodium thiosulfate is preferable.

Particularly, as the metal flat plate particles, from the viewpoint of heat blocking performance and visible ray transmission properties, silver flat plate nanoparticles containing gold are preferable, silver flat plate nanoparticles in which at least a portion of the surface thereof is coated with gold are more preferable, and silver flat plate nanoparticles in which the entire surface thereof is coated with gold are particularly preferable.

The average thickness of gold coating the main flat surface of the metal flat plate particles is preferably equal to or greater than 0.1 nm and equal to or smaller than 2 nm, more preferably equal to or greater than 0.4 nm and equal to or smaller than 1.8 nm, and even more preferably equal to or greater than 0.7 nm and equal to or smaller than 1.5 nm.

The average thickness of gold coating the surface of the metal flat plate particles is obtained by imaging the particles along the direction of a cross section of the particles by using a high-angle annular dark field scanning TEM (HAADF-STEM), measuring the thickness of the gold coating layer, which is found to have high brightness in the captured image, for each of the main flat surface and the end face at 5 spots in one particle by using an image analysis tool such as Image J (provided by National Institute of Health (NIH)), and calculating the arithmetic mean of the thickness of the main flat surface and the end face obtained from a total of 20 particles.

The ratio of the average thickness of gold coating the main flat surface of the particles to the average thickness of gold coating the end face of the particles is preferably equal to or higher than 0.02, more preferably equal to or higher than 0.1, and even more preferably equal to or higher than 0.3. The upper limit of the thickness ratio is not particularly limited, but is preferably equal to or lower than 10. In a case where the thickness ratio is equal to or higher than 0.02, excellent oxidation resistance is exhibited.

˜Silver Flat Plate Nanoparticles˜

The silver flat plate nanoparticles refer to flat plate-like particles having a major axis length and a diameter in a nanoscale (equal to or greater than 1 nm and less than 1,000 nm).

From the viewpoint of visible ray transmission properties and heat blocking performance, it is preferable that the silver flat plate nanoparticles are in the form of a flat plate having two main flat surfaces facing each other as shown in FIG. 1 and FIG. 2.

In the disk-like silver flat plate nanoparticles 35A and 35B (hereinafter, referred to as “silver nanodisk” or “AgND” as well) shown in FIG. 1 and FIG. 2, the major axis length is the equivalent circular diameter D of the main flat surface, and the aspect ratio is a ratio D/T between the equivalent circular diameter D and the distance between the main flat surfaces facing each other, that is, the thickness (plate thickness) of the plate-like metal particle.

The silver nanodisk is a particle comprising two main flat surfaces facing each other as shown in FIG. 1 or FIG. 2. Each of the main flat surface is in the form of a hexagon, a triangle, a circle, and the like, for example. Among these, in view of high visible ray transmittance, the main flat surface is preferably in the form of a polygon having three or more straight sides, and more preferably in the form of a hexagon as shown in FIG. 1 or in the form of a polygon having six or more straight sides or a circle as shown in FIG. 2.

Two or more kinds of silver nanodisks having a plurality of shapes may be used in combination.

Being in the form of a circle means that the number of sides having a length equal to or greater than 50% of the average equivalent circular diameter of silver nanodisks, which will be described later, is 0 in one silver nanodisk particle. The silver nanodisk in the form of a circle is not particularly limited as long as the silver nanodisk is found to have a round shape without a corner in a case where the silver nanodisk is observed from above the main flat surface by using a transmission electron microscope (TEM).

Being in the form of a hexagon means that the number of sides having a length equal to or greater than 20% of the average equivalent circular diameter of silver nanodisks, which will be described later, is 6 in one silver nanodisk. The silver nanodisk in the form of a hexagon is not particularly limited as long as the silver nanodisk is found to be in the form of a hexagon in a case where the silver nanodisk is observed from above the main flat surface by using TEM. The silver nanodisk can be appropriately selected according to the purpose and may be in the form of a hexagon with acute-angled corners or rounded corners. It is preferable that the silver nanodisk has blunted corners because then the absorption in a visible range can be reduced. How much the corners will be blunted is not particularly limited, and can be appropriately selected according to the purpose.

The method for synthesizing the silver nanodisk is not particularly limited, and can be appropriately selected according to the purpose. For example, by liquid phase methods such as a chemical reduction method, a photochemical reduction method, and an electrochemical reduction method, and the like, the silver nanodisk in the form of a hexagon or a circle can be synthesized. Among these, in view of shape and size controllability, liquid phase methods such as a chemical reduction method and a photochemical reduction method are particularly preferable. After the silver nanodisk in the form having 3 to 6 straight sides is synthesized, for example, an etching treatment by a dissolution species dissolving silver such as nitric acid or sodium sulfite or an edging treatment by heating may be performed so as to blunting the corners of the silver nanodisk in the form having 3 to 6 straight sides and to obtain a silver nanodisk in the form of a hexagon or a circle.

In addition, as the method for synthesizing the silver nanodisk, seed crystals may be fixed to the surface of a transparent substrate such as a film or glass, and then the crystals may be allowed to grow.

—Binder—

The binder in the metal flat plate particle-containing layer preferably contains a polymer and more preferably contains a transparent polymer. Examples of the polymer include a polyvinyl acetal resin, a polyvinyl alcohol resin, a polyvinyl butyral resin, a polyacrylate resin, a polymethyl methacrylate resin, a polycarbonate resin, a polyvinyl chloride resin, a (saturated) polyester resin, a polyurethane resin, a polymer such as a natural polymer like gelatin or cellulose, and the like. Among these, a polyvinyl alcohol resin, a polyvinyl butyral resin, a polyvinyl chloride resin, a (saturated) polyester resin, and a polyurethane resin are preferably used as a main polymer. From the viewpoint of making it easy for 80% by number or more of the silver nanoparticles to be present within a range of d/2 from the surface of the metal flat plate particle-containing layer, a polyester resin and a polyurethane resin are more preferably used as a main polymer. Two or more kinds of binders may be used in combination.

Among polyester resins, a saturated polyester resin is particularly preferable because this compound does not contain an ethylenically unsaturated double bond and hence can impart excellent weather fastness. Furthermore, from the viewpoint of obtaining high hardness, high durability, and high heat resistance by curing using a water-soluble curing agent, a water-dispersible curing agent, and the like, a polyester resin having a hydroxyl group or a carboxy group on a molecular terminal is more preferable.

Commercially available polymers can also be preferably used, and examples thereof include PLASCOAT Z-687 as a water-soluble polyester resin manufactured by GOO CHEMICAL CO., LTD., HYDRAN HW-350 as a polyester-polyurethane copolymer manufactured by DIC Corporation, and the like.

In the present specification, the main polymer contained in the metal flat plate particle-containing layer refers to a polymer component taking up 50% by mass or more of the polymers contained in the metal flat plate particle-containing layer.

The content of the binder contained in the metal flat plate particle-containing layer with respect to the content of 100 parts by mass of the metal flat plate particles is preferably 1 part by mass to 10,000 parts by mass, more preferably 10 parts by mass to 1,000 parts by mass, and particularly preferably 20 parts by mass to 500 parts by mass.

The refractive index of the binder is preferably 1.4 to 1.7. The refractive index mentioned herein is a value measured at a wavelength of 550 nm at 25° C. In the present specification, unless otherwise specified, the refractive index is a value measured at a wavelength of 550 nm at 25° C.

From the viewpoint of moist-heat resistance, the metal flat plate particle-containing layer may contain a metal adsorbing compound.

Examples of the metal adsorbing compound contained in the metal flat plate particle-containing layer include 1-phenyl-1H-tetrazole-5-thiol, 5-amino-1,3,4-thiadiazole-2-thiol, 5-phenyl-1,3,4-oxadiazole-2-thiol, methyl ureidophenyl mercaptotetrazole, and the like,

From the viewpoint of visible ray transmission properties and heat blocking performance, the content of the metal adsorbing compound in the metal flat plate particle-containing layer is preferably 0 mg/m² to 2 mg/m², and more preferably 0 mg/m² to 1.5 mg/m².

—Other Additives—

The metal flat plate particle-containing layer may further contain a surfactant, a quick dry accelerator, and the like.

Examples of the surfactant include RAPISOL A-90 (manufactured by NOF CORPORATION, concentration of solid contents: 1%), NAROACTY CL-95 (manufactured by Sanyo Chemical Industries, Ltd., concentration of solid contents: 1%), and the like.

Examples of the quick dry accelerator include an alcohol and the like. As the quick dry accelerator, ethanol is suitably used.

From the viewpoint of visible ray transmission properties and heat blocking performance, the thickness of the metal flat plate particle-containing layer is preferably 10 nm to 500 nm, more preferably 10 nm to 100 nm, and even more preferably 10 nm to 50 nm.

<Dielectric Layer>

From the viewpoint of heat blocking performance, the heat ray-screening material according to the present disclosure preferably further has a dielectric layer, more preferably further has a transparent dielectric layer, and particularly preferably further has at least one transparent dielectric layer between the metal flat plate particle-containing layer A and the metal flat plate particle-containing layer B.

The material of the dielectric layer is not particularly limited as long as the dielectric layer is transparent in a visible range.

In the present disclosure, “transparent” means that the transmittance of light having a wavelength of 550 nm (visible light transmittance which will be described later) is equal to or higher than 40% at 25° C. The transmittance of light is the proportion of amounts of transmitted light to amounts of incidence rays.

In the dielectric layer, at 25° C., the transmittance of light having a wavelength 550 nm is preferably equal to or higher than 80%, and more preferably equal to or higher than 90%.

Examples of the aforementioned material include an inorganic compound, an organic compound, and the like.

Examples of the inorganic compound include silica, quartz, glass, silicon nitride, titania, alumina, aluminum nitride, zinc oxide, germanium oxide, zirconium oxide, niobium oxide, molybdenum oxide, indium oxide, tin oxide, tantalum oxide, tungsten oxide, lead oxide, diamond, boron nitride, carbon nitride, aluminum oxynitride, silicon oxynitride, and the like.

Examples of the organic compound include polycarbonate, polyethylene terephthalate, polybutylene terephthalate, polyethylene naphthalene polymethyl methacrylate, polystyrene, a methylstyrene resin, an acrylonitrile butadiene styrene (ABS) resin, an acrylonitrile styrene (AS) resin, polyethylene, polypropylene, polymethyl pentene, polyoxetane, nylon 6, nylon 66, polyvinyl chloride, polyether sulfone, polysulfone, cellulose triacetate, polyvinyl alcohol, polyacrylonitrile, cyclic polyolefine, an acrylic resin, an epoxy resin, a cyclohexadiene-based polymer, an amorphous polyester resin, transparent polyimide, transparent polyurethane, a transparent fluororesin, a thermoplastic elastomer, polylactic acid, and the like.

The refractive index of the dielectric layer is preferably 1.0 to 10.0, more preferably 1.05 to 5.0, and particularly preferably 1.1 to 4.0.

In a case where the refractive index is equal to or higher than 1.0, it is easy to obtain a uniform dielectric layer as a thin film. In a case where the refractive index is equal to or lower than 10.0, it is easy to form a dielectric layer having a necessary average thickness that is sufficient. The refractive index can be measured, for example, by spectroscopic ellipsometry (VASE manufactured by J. A. Woollam).

From the viewpoint of visible ray transmission properties and heat blocking performance, the dielectric layer preferably does not have maximum absorption in a wavelength range of 400 nm to 700 nm, and more preferably does not have maximum absorption in a wavelength range of 380 nm to 2,500 nm.

From the viewpoint of heat blocking performance, it is preferable that an optical thickness nd of the dielectric layer between the metal flat plate particle-containing layer A and the metal flat plate particle-containing layer B satisfies Formula 1 for a wavelength λ1 at which the reflectance is minimized.

In order to control the reflectance of light having the wavelength λ1 by optical interference, it is advantageous for the dielectric layer to have the optical thickness nd determined by Formula 1.

{(2m+1)×(λ1/4)}−{(λ1/4)×0.20}<nd<{(2m+1)×(λ1/4)}+{(λ1/4)×0.20} (1)

Here, m represents an integer equal to or greater than 0, λ1 represents a wavelength at which a reflectance is minimized, n represents a refractive index of the dielectric layer, d represents a thickness of the dielectric layer, and the unit of λ1 and d is nm.

The optical thickness nd equals the product of the refractive index n of the dielectric layer and the thickness d of the dielectric layer.

In a case where m is 0, based on {(2m+1)×(λ1/4)}, nd in Formula 1 is within a range of ±20% of (λ1/4), more preferably within a range of ±10% of (λ1/4), and particularly preferably within a range of ±5% of (λ1/4).

As long as the optical thickness of at least one layer constituting the dielectric layer satisfies Formula 1, the optical thickness of other layers is not particularly limited. However, from the viewpoint of heat blocking performance, m in Formula 1 is preferably 0 or 1, and more preferably 0.

In order to widen the wavelength range in which the reflectance can be controlled and to obtain a heat ray-screening material which undergoes only a small change in tint or reflectance even though light is obliquely incident thereon, it is advantageous that m in Formula 1 is 0 or 1.

From the viewpoint of heat blocking performance, in a case where m in Formula 1 is 0, it is preferable that the metal flat plate particle-containing layer B is disposed to be closer to the side of a solar radiation incoming direction than the metal flat plate particle-containing layer A is. In a case where m in Formula 1 is 1, it is preferable that the metal flat plate particle-containing layer A is disposed to be closer to the side of the solar radiation incoming direction than the metal flat plate particle-containing layer B is.

From the viewpoint of visible ray transmission properties and heat blocking performance, the wavelength λ1 at which the reflectance is minimized is preferably 380 nm to 780 nm, and more preferably 400 nm to 700 nm.

The thickness of the dielectric layer is preferably 5 nm to 5,000 nm, more preferably 10 nm to 3,000 nm, and particularly preferably 20 nm to 1,000 nm.

In a case where the thickness is equal to or greater than 5 nm, it is easy to form a film with high smoothness as a dielectric layer. In a case where the thickness is equal to or smaller than 5,000 nm, the effect of optical interference between the metal flat plate particle-containing layer A and the metal flat plate particle-containing layer B is fully obtained.

The method for forming the dielectric layer is not particularly limited, and can be appropriately selected according to the purpose. Examples thereof include a method of forming the dielectric layer by disposing a layer of a substance having the refractive index n such that the thickness thereof becomes d. The deposition method is not particularly limited, and can be appropriately selected according to the purpose. For example, it is preferable to laminate the layer by a vapor deposition method that can precisely control the thickness (including vacuum vapor deposition, ion assisted vapor deposition, ion plating vapor deposition, ion beam sputtering vapor deposition, and the like), a chemical vapor deposition (CVD) method, and the like.

<Ultraviolet Absorbing Layer>

From the viewpoint of light fastness, it is preferable that the heat ray-screening material according to the present disclosure further has an ultraviolet absorbing layer. Furthermore, it is preferable that the ultraviolet absorbing layer contains an ultraviolet absorber.

From the viewpoint of light fastness and heat blocking performance, in the heat ray-screening material according to the present disclosure, it is preferable that the ultraviolet absorbing layer is closer to the side of the solar radiation incoming direction than the metal flat plate particle-containing layer A and the metal flat plate particle-containing layer B are.

In the present disclosure, “solar radiation incoming direction” refers to a direction along which light including heat rays such as sunlight is strongly radiated in a case where the heat ray-screening material according to the present disclosure is used.

Furthermore, in the present disclosure, the ultraviolet absorber is preferably a compound absorbing at least a portion of ultraviolet having a wavelength equal to or longer than 300 nm and shorter than 400 nm.

In addition, the ultraviolet absorber may be a low-molecular-weight compound or a polymer having an ultraviolet absorbing group.

From the viewpoint of light fastness, the ultraviolet absorber is preferably at least one kind of ultraviolet absorber selected from the group consisting of a benzophenone-based ultraviolet absorber, a benzotriazole-based ultraviolet absorber, a triazine-based ultraviolet absorber, a salicylic acid-based ultraviolet absorber, and an oxalic acid diamide-based ultraviolet absorber, and more preferably at least one kind of ultraviolet absorber selected from the group consisting of a benzophenone-based ultraviolet absorber, a benzotriazole-based ultraviolet absorber, and a triazine-based ultraviolet absorber.

As the triazine-based ultraviolet absorber, a compound having a triazine structure may be used. Examples thereof include 2-(4-butoxy-2-hydroxyphenyl)-4,6-bis(4-butoxyphenyl)-1,3,5-triazine, 2-(4-butoxy-2-hydroxyphenyl)-4,6-bis(2,4-dibutoxyphenyl)-1,3,5-triazine, 2,4-bis(4-butoxy-2-hydroxyphenyl)-6-(4-butoxyphenyl)-1,3,5-triazine, 2,4-bis(4-butoxy-2-hydroxyphenyl)-6-(2,4-dibutoxyphenyl)-1,3,5-triazine, 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)phenyl]-4,6-bis(2,4-dimethyl)-1,3,5-triazine, 2-[2-hydroxy-4-(2-hydroxy-3-octyloxypropyloxy)phenyl]-4,6-bis(2,4-dimethyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis(2,4-dimethylphenyl-1,3,5-triazine, 2-(2-hydroxy-4-hexyloxy)phenyl-4,6-diphenyl-1,3,5-triazine, 2-(2-hydroxy-4-methoxyphenyl)-4,6-diphenyl-1,3,5-triazine, 2,4,6-tris(2-hydroxy-4-(3-butoxy-2-hydroxypropoxy)phenyl-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxy-propyloxy]phenyl}-4,6-bis(2,4-dimethylphenyl)-1,3,5-triazine, 2-(2-hydroxy-4-(2-ethylhexyl)oxy)phenyl-4,6-bis(4-phenyl)phenyl-1,3,5-triazine, and the like.

As the benzotriazole-based ultraviolet absorber, a compound having a benzotriazole structure may be used. Examples thereof include 2-(2′-hydroxy-5′-methylphenyl)benzotriazole, 2-(2′-hydroxy-5′-t-butylphenyl)benzotriazole, 2-(2′-hydroxy-3′-t-butyl-5′-methylphenyl)-5-chlorobenzotriazole, 2-(2′-hydroxy-3′,5′-di-t-butylphenyl)-5-chlorobenzotriazole, 2-(2′-hydroxy-3′-dodecyl-5′-methylphenyl)-5-chlorobenzotriazole, 2-(2′-hydroxy-3′,5′-di-t-amylphenyl)benzotriazole, 2-(2′-hydroxy-5′-(1,1,3,3-tetramethylbutyl)phenyl)benzotriazole, 2-(2′-hydroxy-4′-octyloxyphenyl)benzotriazole, 2-(2′-hydroxy-3′-(3,4,5,6-tetrahydrophthalimidylmethyl)-5′-methylbenzyl)phenyl)benzotriazole, 2-(3′-sec-butyl-5′-t-butyl-2′-hydroxyphenyl)benzotriazole, 2-(3′,5′-bis-(α,α-dimethylbenzyl)-2′-hydroxyphenyl)benzotriazole, 2-(3′-t-butyl-2′-hydroxy-5′-(2-octyloxycarbonylethyl)phenyl)-5-chloro-benzotriazole, 2-(3′-t-butyl-5′-[2-(2-ethylhexyloxy)-carbonylethyl]-2′-hydroxyphenyl)-5-chloro-benzotriazole, 2-(3′-t-butyl-2′-hydroxy-5′-(2-methoxycarbonylethyl)phenyl)-5-chloro-benzotriazole, 2-(3′-t-butyl-2′-hydroxy-5′-(2-methoxycarbonylethyl)phenyl)benzotriazole, 2-(3′-t-butyl-2′-hydroxy-5′-(2-octyloxycarbonylethyl)phenyl)benzotriazole, 2-(3′-t-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole, 2-(3′-t-butyl-2′-hydroxy-5′-(2-isooctyloxycarbonylethyl)phenyl benzotriazole, 2,2′-methylene-bis[4-(1,1,3,3-tetramethylbutyl)-6-benzotriazol-2-yl phenol], and the like.

As the benzophenone-based ultraviolet absorber, a compound having a benzophenone structure may be used. Examples thereof include 2,4-dihydroxybenzophenone, 2-hydroxy-4-methoxybenzophenone, 2-hydroxy-4-octyloxybenzophenone, 2-hydroxy-4-decyloxybenzophenone, 2-hydroxy-4-dodecyloxybenzophenone, 2-hydroxy-4-benzyloxybenzophenone, 2-hydroxy-4-(2-hydroxy-3-methacryloxypropoxy)benzophenone, 2-hydroxy-4-methoxy-5-sulfobenzophenone, 2-hydroxy-4-methoxy-5-sulfobenzophenone trihydrate, 2-hydroxy-4-methoxy-2′-carboxybenzophenone, 2-hydroxy-4-octadecyloxybenzophenone, 2-hydroxy-4-diethylamino-2′-hexyloxycarbonyl benzophenone, 2,2′-dihydroxy-4-methoxybenzophenone, 2,2′,4,4′-tetrahydroxybenzophenone, 2,2′-dihydroxy-4,4′-dimethoxybenzophenone, 1,4-bis(4-benzyloxy-3-hydroxyphenoxy)butane, and the like.

As the salicylic acid-based ultraviolet absorber, a compound having a salicylic acid structure may be used. Examples thereof include phenyl salicylate, 4-t-butylphenyl salicylate, 4-octylphenyl salicylate, dienzoyl resorcinol, bis(4-t-butylbenzoyl)resorcinol, benzoyl resorcinol, 2,4-di-t-butylphenyl 3,5-di-t-butyl-4-hydroxysalicylate, hexadecyl 3,5-di-t-butyl-4-hydroxysalicylate, and the like.

As the oxalic acid diamide-based ultraviolet absorber, a compound having an oxalic acid diamide structure may be used. Examples thereof include 4,4′-dioctyloxyoxanilide, 2,2′-dioctyloxy-5,5′-di-t-butyloxanilide, 2,2′-didodecyloxy-5,5′-di-t-butyloxanilide, 2-ethoxy-2′-ethyloxanilide, N,N′-bis(3-dimethylaminopropyl)oxanilide, 2-ethoxy-5-t-butyl-2′-ethyloxanilide, 2-ethoxy-2′-ethyl-5,4′-di-t-butyloxanilide, and the like.

Examples of the polymer having an ultraviolet absorbing group include TINUVIN (registered trademark) 99-DW, 400-DW, 477-DW, and 479-DW (manufactured by BASF SE), UNICOAT (registered trademark) UVA-204W, UVA-101, UVA-102, UVA-103, and UVA-104, VANARESIN (registered trademark) UVA-5080, UVA-5080 (OHV20), UVA-55T, UVA-55MHB, UVA-7075, UVA-7075 (OHV20), and UVA-73T (manufactured by SHIN-NAKAMURA CHEMICAL CO., LTD.), RUVA-93 (manufactured by Otsuka Chemical Co., Ltd.), and the like.

From the viewpoint of light fastness, the weight-average molecular weight of the polymer having an ultraviolet absorbing group is preferably 5,000 to 200,000, more preferably 7,000 to 150,000, and even more preferably 10,000 to 100,000.

The ultraviolet absorbing layer may contain only one kind of ultraviolet absorber or two or more kinds of ultraviolet absorbers.

From the viewpoint of light fastness, the content of the ultraviolet absorber in the ultraviolet absorbing layer with respect to the total mass of the ultraviolet absorbing layer is preferably 0.1% by mass to 50% by mass, more preferably 0.3% by mass to 35% by mass, and even more preferably 10% by mass to 25% by mass.

Furthermore, from the viewpoint of light fastness, the content of the ultraviolet absorber in the ultraviolet absorbing layer is preferably 0.1 g/m² to 10 g/m², more preferably 0.3 g/m² to 8 g/m², even more preferably 0.5 g/m² to 5 g/m², and particularly preferably 2 g/m² to 5 g/m².

—Other Components—

If necessary, the ultraviolet absorbing layer may further contain other components such as various additives, for example, a binder, a crosslinking catalyst, a surfactant, a filler, a light stabilizer, and the like.

Furthermore, as a component forming the ultraviolet absorbing layer, a crosslinking agent may be used.

Examples of the binder include an acrylic resin, a polyester resin, a polyurethane resin, a polyolefin resin, a silicone resin, a fluororesin, and the like. The binder may be a composite resin such as a siloxane-containing acrylic resin obtained by combining an acrylic resin with a silicone resin.

˜Crosslinking Agent˜

Examples of the crosslinking agent include crosslinking agents such as an epoxy-based crosslinking agent, an isocyanate-based crosslinking agent, a melamine-based crosslinking agent, a carbodiimide-based crosslinking agent, and an oxazoline-based crosslinking agent. Among these, at least one or more kinds of crosslinking agents selected from the group consisting of a carbodiimide-based crosslinking agent, an oxazoline-based crosslinking agent, and an isocyanate-based crosslinking agent are preferable.

Examples of the oxazoline-based crosslinking agent include 2-vinyl-2-oxazoline, 2-vinyl-4-methyl-2-oxazoline, 2-vinyl-5-methyl-2-oxazoline, 2-isopropenyl-2-oxazoline, 2-isopropenyl-4-methyl-2-oxazoline, 2-isopropenyl-5-ethyl-2-oxazoline, 2,2′-bis-(2-oxazoline), 2,2′-methylenebis(2-oxazoline), 2,2′-ethylenebis(2-oxazoline), 2,2′-trimethylenebis(2-oxazoline), 2,2′-tetramethylenebis(2-oxazoline), 2,2′-hexamethylenebis(2-oxazoline), 2,2′-octamethylenebis(2-oxazoline), 2,2′-ethylenebis(4,4′-dimethyl-2-oxazoline), 2,2′-p-phenylenebis(2-oxazoline), 2,2′-m-phenylenebis(2-oxazoline), 2,2′-m-phenylenebis(4,4′-dimethyl-2-oxazoline), bis(2-oxazolinylcyclohexane)sulfide, bis(2-oxazolinylnorbornane)sulfide, and the like. Furthermore, a (co)polymer of these compounds can be preferably used.

As the oxazoline-based crosslinking agent, commercial products may also be used. For example, it is possible to use EPOCROS (registered trademark) K-2010E, K-2020E, K-2030E, WS-500, and WS-700 [manufactured by NIPPON SHOKUBAI CO., LTD.], and the like.

One kind of crosslinking agent may be used singly, or two or more kinds of crosslinking agents may be used in combination.

In a case where a crosslinking agent is used in the ultraviolet absorbing layer, the amount of the crosslinking agent added with respect to 100 parts by mass of the binder contained in the ultraviolet absorbing layer is preferably equal to or greater than 10 parts by mass and equal to or smaller than 40 parts by mass, and more preferably equal to or greater than 15 parts by mass and equal to or smaller than 35 parts by mass. In a case where the amount of the crosslinking agent added is equal to or greater than 10 parts by mass, it is possible to obtain a sufficient crosslinking effect while maintaining the hardness and the adhesiveness of the layer having weather fastness. In a case where the amount of the crosslinking agent added is equal to or smaller than 40 parts by mass, the pot life of the coating solution increases, and in a case where the amount of the crosslinking agent added is equal to or smaller than 35 parts by mass, the condition of the coated surface can be improved.

˜Crosslinking Catalyst˜

In a case where the ultraviolet absorbing layer contains a crosslinking agent, a crosslinking catalyst may be used in combination with the crosslinking agent. In a case where the ultraviolet absorbing layer contains a crosslinking catalyst, the crosslinking reaction between the resin component and the crosslinking agent is accelerated, and solvent resistance can be improved. Furthermore, the crosslinking excellently proceeds, and accordingly, the hardness of the undercoat layer and the dimensional stability can be further improved.

Particularly, in a case where an oxazoline group-containing crosslinking agent (oxazoline-based crosslinking agent) is used as a crosslinking agent, it is preferable to use a crosslinking catalyst.

Examples of the crosslinking catalyst include an onium compound.

As the onium compound, for example, an ammonium salt, a sulfonium salt, an oxonium salt, an iodonium salt, a phosphonium salt, a nitronium salt, a nitrosonium salt, a diazonium salt, and the like are suitable.

Specific examples of the onium compound include an ammonium salt such as ammonium phosphate monobasic, ammonium phosphate dibasic, ammonium chloride, ammonium sulfate, ammonium nitrate, ammonium p-toluenesulfonate, ammonium sulfamate, ammonium imidodisulfonate, tetrabutyl ammonium chloride, benzyltrimethyl ammonium chloride, triethylbenzyl ammonium chloride, tetrabutyl ammonium tetrafluoroborate, tetrabutylammonium hexafluorophosphate, tetrabutylammonium perchlorate, or tetrabutylammonium sulfate;
a sulfonium salt such as trimethylsulfonium iodide, trimethylsulfonium tetrafluoroborate, diphenylmethylsulfonium tetrafluoroborate, benzyltetramethylsulfonium tetrafluoroborate, 2-butenyltetramethylenesulfonium hexafluoroantimonate, or 3-methyl-2-butenyltetramethylenesulfonium hexafluoroantimonate;
an oxonium salt such as trimethyloxonium tetrafluoroborate;
an iodonium salt such as diphenyliodonium chloride or diphenyliodonium tetrafluoroborate;
a phosphonium salt such as cyanomethyltributylphosphonium hexafluoroantimonate or ethoxycarbonylmethyl tributylphosphonium tetrafluoroborate;
a nitronium salt such as nitronium tetrafluoroborate;
a nitrosonium salt such as nitrosonium tetrafluoroborate;
a diazonium salt such as 4-methoxybenzenediazonium chloride; and the like.

Among these, as the onium compound, in view of reactivity, an ammonium salt, a sulfonium salt, an iodonium salt, and a phosphonium salt are more preferable, and an ammonium salt is even more preferable. From the viewpoint of pH and costs, onium compounds based on phosphoric acid and benzyl chloride are preferable. As the onium compound, ammonium phosphate dibasic is particularly preferable.

One kind of crosslinking catalyst may be used singly, or two or more kinds of crosslinking catalysts may be used in combination.

The amount of the crosslinking catalyst added with respect to the total mass of the crosslinking agent used is preferably within a range equal to or greater than 0.1% by mass and equal to or smaller than 15% by mass, more preferably within a range equal to or greater than 0.5% by mass and equal to or less than 12% by mass, particularly preferably within a range equal to or greater than 1% by mass and equal to or smaller than 10% by mass, and more particularly preferably within equal to or greater than 2% by mass and equal to or smaller than 7% by mass. In a case where the amount of the crosslinking catalyst added with respect to the crosslinking agent is equal to or greater than 0.1% by mass, this means that the crosslinking catalyst is actively incorporated into the ultraviolet absorbing layer. In a case where the ultraviolet absorbing layer contains the crosslinking catalyst, the crosslinking reaction between the polymer as a binder having a yield point and the crosslinking agent proceeds better, and higher durability is obtained. Furthermore, in view of solubility, filtering properties of the coating solution, and adhesiveness between the adjacent layers, it is advantageous that the content of the crosslinking catalyst is equal to or smaller than 15% by mass.

˜Surfactant˜

Examples of the surfactant include known surfactants such as an anionic surfactant and a nonionic surfactant. In a case where the surfactant is added, the amount of the surfactant added is preferably 0.1 mg/m² to 10 mg/m², and more preferably 0.5 mg/m² to 3 mg/m². In a case where the amount of the surfactant added is equal to or greater than 0.1 mg/m², it is possible to form a layer while inhibiting the occurrence of cissing. In a case where the amount of the surfactant added is equal to or smaller than 10 mg/m², the ultraviolet absorbing layer can be excellently bonded to a substrate and the like.

˜Filler˜

As the filler, known fillers such as silica particles can be used.

Details of the filler will be described regarding a hardcoat layer which will be described later.

˜Light Stabilizer˜

Examples of the light stabilizer include known light stabilizers such as a hindered amine-based light stabilizer. As commercial light stabilizers, it is possible to use TINUVIN (registered trademark) 123-DW (manufactured by BASF SE), UDOUBLE (registered trademark) E-771SI (manufactured by NIPPON SHOKUBAI CO., LTD.), and the like. In a case where the light stabilizer is added, the amount thereof added is preferably 0.1 g/m² to 5 g/m², and more preferably 0.3 g/m² to 3 g/m². In a case where the amount of the light stabilizer added is equal to or greater than 0.1 g/m², excellent weather fastness is obtained. In a case where the amount of the light stabilizer added is equal to or smaller than 5 g/m², bleed out can be inhibited.

The method for forming the ultraviolet absorbing layer is not particularly limited. Examples of the method for forming the ultraviolet absorbing layer include a method of coating one surface of a substrate with a coating solution containing an ultraviolet absorber, a binder polymer, and the like and drying the coating solution.

The coating method and the solvent of the coating solution used are not particularly limited. Examples of the coating method include coating using a gravure coater or a bar coater. The solvent used in the coating solution may be water or an organic solvent such as toluene or methyl ethyl ketone. From the viewpoint of environmental load, it is preferable to prepare an aqueous coating solution using water as a solvent.

One kind of coating solvent may be used singly, or two or more kinds of coating solvents may be used by being mixed together.

Before the ultraviolet absorbing layer is provided by coating, a surface treatment (a flame treatment, a corona treatment, a plasma treatment, an ultraviolet treatment, or the like) may be performed on the substrate.

The ultraviolet absorbing layer may be disposed on a substrate through another layer (for example, the undercoat layer which will be described later).

The thickness of the ultraviolet absorbing layer is preferably 100 nm to 20 μm, more preferably 200 nm to 15 μm, and even more preferably 500 nm to 4 μm.

In a case where the thickness of the ultraviolet absorbing layer is equal to or greater than 100 nm, the ultraviolet absorbing layer more easily expresses its function. In a case where the thickness of the ultraviolet absorbing layer is equal to or smaller than 20 μm, visible ray transmittance in the ultraviolet absorbing layer is further improved.

<Substrate>

The heat ray-screening material according to the present disclosure may have a substrate.

As the substrate, a transparent substrate is preferable.

The material of the substrate can be appropriately selected. As the material of the substrate, a polymer is preferable, and a thermoplastic resin is more preferable. Examples of the polymer include polyolefin such as polyester, polycarbonate, polypropylene, or polyethylene, a fluorine-based polymer such as polyvinyl fluoride, and the like. Among these, from the viewpoint of costs, mechanical strength, and light transmission properties, polyester is preferable.

Examples of the polyester include linear saturated polyester synthesized from an aromatic dibasic acid or a derivative thereof forming an ester and a diol or a derivative thereof forming an ester. Specific examples of the linear saturated polyester include polyethylene terephthalate, polyethylene isophthalate, polybutylene terephthalate, poly(1,4-cyclohexylenedimethyleneterephthalate), polyethylene-2,6-naphthalate, and the like. Among these, in view of balance between mechanical physical properties and costs, polyethylene terephthalate, polyethylene-2,6-naphthalate, and poly(1,4-cyclohexylenedimethyleneterephthalate) are particularly preferable.

The polyester may be a homopolymer or a copolymer. Furthermore, the polyester may be blended with small amounts of another type of resin such as polyimide.

The type of the polyester is not particularly limited, and known polyester may be used. As the known polyester, polyester synthesized using a dicarboxylic acid component and a diol component may be used, or commercial polyester may be used.

In a case where the polyester is synthesized, for example, by subjecting (a) dicarboxylic acid component and (b) diol component to at least one of the esterification reaction or the ester exchange reaction by a known method, the polyester can be obtained.

Examples of (a) dicarboxylic acid component include dicarboxylic acids or ester derivatives thereof including aliphatic carboxylic acids such as malonic acid, succinic acid, glutaric acid, adipic acid, suberic acid, sebacic acid, dodecanedioic acid, dimer acid, eicosanedioic acid, pimelic acid, azelaic acid, methylmalonic acid, and ethylmalonic acid; alicyclic dicarboxylic acids such as adamantane dicarboxylic acid, norbornene dicarboxylic acid, cyclohexane dicarboxylic acid, and decalin dicarboxylic acid; and aromatic dicarboxylic acids such as terephthalic acid, isophthalic acid, phthalic acid, 1,4-naphthalene dicarboxylic acid, 1,5-naphthalene dicarboxylic acid, 2,6-naphthalene dicarboxylic acid, 1,8-naphthalene dicarboxylic acid, 4,4′-diphenyl dicarboxylic acid, 4,4′-diphenylether dicarboxylic acid, 5-sodium sulfoisophthalic acid, phenylindane dicarboxylic acid, anthracene dicarboxylic acid, phenanthrene dicarboxylic acid, and 9,9′-bis(4-carboxyphenyl)fluorene acid.

Examples of (b) diol component include diol compounds including aliphatic diols such as ethylene glycol, 1,2-propanediol, 1,3-propanediol, 1,4-butanediol, 1,2-butanediol, and 1,3-butanediol; alicyclic diols such as cyclohexane dimethanol, spiroglycol, and isosorbide; and aromatic diols such as bisphenol A, 1,3-benzenedimethanol, 1,4-benzenedimethanol, and 9,9′-bis(4-hydroxyphenyl)fluorene.

The polyester film containing polyester as a raw material resin may contain at least one of the carbodiimide compound or the ketenimine compound. Each of the carbodiimide compound and the ketenimine compound may be used singly, or the carbodiimide compound and the ketenimine compound may be used in combination. In a case where the carbodiimide compound or the ketenimine compound is used, it is possible to inhibit the polyester from deteriorating in a moist and hot environment.

The content of the carbodiimide compound or the ketenimine compound with respect to the polyester is preferably 0.1% by mass to 10% by mass, more preferably 0.1% by mass to 4% by mass, and even more preferably 0.1% by mass to 2% by mass. In a case where the content of the carbodiimide compound or the ketenimine compound is within the above range, it is possible to further improve the adhesiveness between the substrate and a layer adjacent thereto, and to improve the heat resistance of the substrate.

In a case where the carbodiimide compound and the ketenimine compound are used in combination, the total content rate of two kinds of the compounds is preferably within the above range.

Examples of the polycarbonate include diol polycarbonate. The diol polycarbonate is generated through a reaction such as a methanol-removing condensation reaction between a dihydric alcohol and dimethyl carbonate, a phenol-removing condensation reaction between a dihydric alcohol and diphenyl carbonate, or an ethylene glycol-removing condensation reaction between a dihydric alcohol and ethylene carbonate. Examples of polyhydric alcohols used in these reactions include various saturated or unsaturated glycols such as 1,6-hexanediol, diethylene glycol, triethylene glycol, propylene glycol, 1,3-butanediol, 1,4-butanediol, neopentyl glycol, pentanediol, 3-methyl-1,5-pentanediol, octanediol, 1,4-butynediol, dipropylene glycol, tripropylene glycol, and polytetramethylene ether glycol, alicyclic glycols such as 1,4-cyclohexane diglycol and 1,4-cyclohexane dimethanol, and the like.

From the viewpoint of light transmission properties and handleability, the thickness of the substrate is preferably 20 μm to 150 μm, more preferably 30 μm to 120 μm, even more preferably 40 μm to 100 μm, and particularly preferably 50 μm to 80 μm.

<Undercoat Layer>

In order to improve the adhesiveness with respect to the layers which will be described later, the heat ray-screening material according to the present disclosure may have an undercoat layer between the layers, for example, on the surface of the substrate.

The components incorporated into the undercoat layer are not particularly limited. From the viewpoint of adhesiveness, it is preferable that the undercoat layer contains a resin, a surfactant, a pH adjuster, a lubricant, wax, and the like.

The thickness of the undercoat layer is not particularly limited. From the viewpoint of adhesiveness, the thickness of the undercoat layer is preferably 1 nm to 1 μm, more preferably 10 nm to 500 nm, and even more preferably 10 nm to 150 nm.

<Pressure Sensitive Adhesive Layer>

The heat ray-screening material according to the present disclosure may have a pressure sensitive adhesive layer. In a case where the heat ray-screening material has a pressure sensitive adhesive layer, it is possible to easily bond the heat ray-screening material according to the present disclosure to the desired site.

The pressure sensitive adhesive used in the present disclosure is not particularly limited.

The pressure sensitive adhesive may be in the form of a solvent-based pressure sensitive adhesive, a solventless pressure sensitive adhesive, a water dispersion-type pressure sensitive adhesive, or a solid-based pressure sensitive adhesive.

Examples of the pressure sensitive adhesive include an acrylic pressure sensitive adhesive, a urethane-based pressure sensitive adhesive, a silicone-based pressure sensitive adhesive, a rubber-based pressure sensitive adhesive, and the like.

As the pressure sensitive adhesive, commercial products can be used.

Examples of commercial acrylic pressure sensitive adhesives include ARONTACK (registered trademark, the same is true in the following description) HV-C3050, ARONTACK HV-C9500, ARONTACK HV-C9506, ARONTACK HV-C3006, ARONTACK HV-C6320, ARONTACK HV-C5166, ARONTACK RP-275, ARONTACK S-1601, ARONTACK S-1616 ARONTACK S-3403, and modified ARONTACK S-1511 from TOAGOSEI CO., LTD.; AQUATRAN (registered trademark, the same is true in the following description) EX202(A), AQUATRAN EX202(B), AQUATRAN EX202(D), N801-A, and N-730-A from EMULSION TECHNOLOGY CO., LTD.; AT-193, AT-D40, AT-D50N, AT-D45, AT-D37, AT-D54N, AT-191HS, AT-191, AT-260NT, AT-527, AT-27, AT-1202, AT-1205, AT-21A, and AT-290 from Saiden Chemical Industry Co., Ltd.; Nipol (registered trademark, the same is true in the following description) LX 811H, Nipol LX 851E, Nipol LX 857X2, Nipol LX 874, and Nipol SX1706A from ZEON CORPORATION; and the like.

Examples of commercial urethane-based pressure sensitive adhesives include ORIBAIN (registered trademark, the same is true in the following description) SP-205, ORIBAIN SH-109, ORIBAIN SH-101, and ORIBAIN SH-101M from TOYOCHEM CO., LTD., and the like.

Examples of commercial silicone-based pressure sensitive adhesives include SD4584, SD4585, SD4560, SD4570, SD4580, and SD4587 from Dow Corning Toray Co., Ltd., and the like.

Examples of commercial rubber-based pressure sensitive adhesives include Nipol (registered trademark, the same is true in the following description) LX430, Nipol KX415, and Nipol SX1105A from ZEON CORPORATION; ORIBAIN (registered trademark) BPS5079-1 from TOYOCHEM CO., LTD., and the like.

The pressure sensitive adhesive layer may contain only one kind of pressure sensitive adhesive or two or more kinds of pressure sensitive adhesives.

The content of the pressure sensitive adhesive in the pressure sensitive adhesive layer is not particularly limited. For example, from the viewpoint of pressure sensitive adhesion, the content of the pressure sensitive adhesive with respect to the total mass of the pressure sensitive adhesive layer is preferably equal to or greater than 50% by mass and equal to or smaller than 99% by mass, more preferably equal to or greater than 60% by mass and equal to or smaller than 98% by mass, and even more preferably equal to or greater than 70% by mass and equal to or smaller than 97% by mass.

As described above, the pressure sensitive adhesive layer may contain an ultraviolet absorber. In a case where the pressure sensitive adhesive layer contains an ultraviolet absorber, an ultraviolet absorbing layer does not need to be additionally formed, and accordingly, it is easy to make the heat ray-screening material as a thin film.

The ultraviolet absorber has the same definition as the ultraviolet absorber described above regarding the ultraviolet absorbing layer, and preferred aspects thereof are also the same.

The content of the ultraviolet absorber in the pressure sensitive adhesive layer is not particularly limited. For example, the content of the ultraviolet absorber with respect to the total mass of the pressure sensitive adhesive layer is preferably equal to or greater than 0.1% by mass and equal to or smaller than 20% by mass, and more preferably equal to or greater than 0.5% by mass and equal to or smaller than 15% by mass.

From the viewpoint of light fastness, the content of the ultraviolet absorber in the pressure sensitive adhesive layer is preferably 0.1 g/m² to 10 g/m², more preferably 0.3 g/m² to 8 g/m², even more preferably 0.5 g/m² to 5 g/m², and particularly preferably 2 g/m² to 5 g/m².

The thickness of the pressure sensitive adhesive layer is not particularly limited, and can be appropriately set according to the use, required performance, and the like.

For example, from the viewpoint of productivity, the thickness of the pressure sensitive adhesive layer is preferably set within a range of 5 μm to 100 μm, and more preferably set within a range of 10 μm to 50 μm.

<Release Layer>

From the viewpoint of handleability, the heat ray-screening material according to the present disclosure may have a release layer on a surface thereof.

The release layer is preferably a peelable layer.

Examples of the material of the release layer include a resin film, paper, and the like. Furthermore, a known release film, release paper, laminated paper, and the like can be suitably used.

The thickness of the release layer is not particularly limited, and can be appropriately selected. For example, a suitable thickness of the release layer is 0.01 μm to 100 μm.

The heat ray-screening material according to the present disclosure may have other layers in addition to the layers described above.

Examples of those other layers include known layers such as an adhesive layer, an easily adhesive layer, a hardcoat layer, an overcoat layer, a backcoat layer, and the like.

Regarding those other layers, for example, JP2014-194446A can be referred to.

—Transmittance of Heat Ray-Screening Material—

From the viewpoint of versatility, the visible light transmittance of the heat ray-screening material according to the present disclosure is preferably equal to or higher than 40%, more preferably equal to or higher than 50%, and even more preferably equal to or higher than 60%.

From the viewpoint of light fastness, the transmittance of the heat ray-screening material according to the present disclosure at 400 nm is preferably equal to or lower than 90%, more preferably equal to or lower than 85%, even more preferably equal to or lower than 80%, and still more preferably equal to or lower than 60%.

In the present disclosure, the visible light transmittance is a transmittance of visible light having a wavelength of 550 nm that is measured at 25° C. The transmittance at 400 nm is a transmittance of light having a wavelength of 400 nm that is measured at 25° C.

The visible light transmittance and the transmittance at 400 nm of the substrate are measured using an ultraviolet-visible-near infrared spectrophotometer (manufactured by JASCO Corporation, V-670). The measurement conditions are as below. By setting a wavelength range, the visible light transmittance and the transmittance at 400 nm are measured.
Measurement mode: % T
Range of measurement: 2,500 nm to 300 nm
UV/VIS band width: 5 nm
NIR band width: 20 nm
Scanning speed: 1,000 nm/min

As described above, the layer constitution of the heat ray-screening material according to the present disclosure is not particularly limited, as long as the heat ray-screening material has a particle-containing layer containing metal flat plate particles and an adjacent layer adjacent to the particle-containing layer on a substrate. If necessary, the layers described above may be provided in the heat ray-screening material.

Furthermore, the heat ray-screening material may further have known layers in addition to the layers described above.

—Use of Heat Ray-Screening Material—

The heat ray-screening material according to the present disclosure may be singly used as it is or may be laminated with another functional layer. Furthermore, the heat ray-screening material according to the present disclosure may be made into a heat blocking glass by being laminated with glass or the like. In addition, the heat ray-screening material according to the present disclosure may be interposed between laminated glasses or may be used as laminated glass.

The heat ray-screening material according to the present disclosure is not particularly limited as long as the heat ray-screening material is used for selectively reflecting (or absorbing if necessary) at least a portion of heat rays (near infrared), and may be appropriately selected according to the purpose. For example, the heat ray-screening material is used as a film or a laminated structure for vehicles, a film or a laminated structure for building materials, an agricultural film, and the like. Among these, in view of energy saving effects, a film or a laminated structure for vehicles and a film or a laminated structure for building materials are preferable.

In the present disclosure, heat rays (near infrared) mean near infrared (780 nm to 1,800 nm). The near infrared at 780 nm to 1,800 nm accounts for about 50% of sunlight.

(Heat Blocking Glass)

The heat blocking glass according to the present disclosure includes the heat ray-screening material according to the present disclosure that has a pressure sensitive adhesive layer and glass that is provided on the pressure sensitive adhesive layer.

It is preferable that the heat ray-screening material according to the present disclosure is laminated to the inside of a glass window or a transparent resin window such that the ultraviolet absorbing layer and the metal flat plate particle-containing layer are arranged in this order from the solar radiation incidence side (side of sunlight).

Furthermore, the heat ray-screening material according to the present disclosure may be bonded to the solar radiation incidence side of glass. At this time, in order to prevent heating, it is preferable that a reflection layer faces the solar radiation incidence side. Accordingly, it is preferable to use the heat ray-screening material according to the present disclosure in which the ultraviolet absorbing layer is closer to the solar radiation incidence side than the metal flat plate particle-containing layer is.

(Interlayer for Laminated Glass and Laminated Glass)

An interlayer for laminated glass according to the present disclosure includes the heat ray-screening material according to the present disclosure.

Furthermore, laminated glass according to the present disclosure has the interlayer for laminated glass according to the present disclosure and at least two sheets of glass plates, in which the interlayer for laminated glass is between two sheets of the glass.

<Interlayer>

It is preferable that the interlayer for laminated glass according to the present disclosure further includes an interlayer (first interlayer) in addition to the heat ray-screening material according to the present disclosure.

In addition, it is more preferable that the interlayer for laminated glass according to the present disclosure further includes a second interlayer. Moreover, the first and second interlayers may have the same composition or different compositions.

The thickness of the first and second interlayers is preferably 100 μm to 1,000 μm, and more preferably 200 μm to 800 μm. Furthermore, the first and second interlayers may be prepared as a thick film by stacking a plurality of sheets.

In addition, the elongation at break of the first and second interlayers that is measured by a tensile test is preferably 100% to 800%, more preferably 100% to 600%, and particularly preferably 200% to 500%.

Each of the first and second interlayers is preferably a resin interlayer.

The resin interlayer is preferably a resin film containing polyvinyl acetal as a main component (polyvinyl acetal-based resin film).

As the polyvinyl acetal-based resin film, for example, those described in JP1994-000926A (JP-H06-000926A), JP2007-008797A, and the like can be preferably used without particular limitation. Among the polyvinyl acetal-based resin films, a polyvinyl butyral resin film is preferably used. The polyvinyl butyral resin film is not particularly limited as long as it is a resin film containing polyvinyl butyral as a main component. It is possible to adopt widely known polyvinyl butyral resin films. Among these, the aforementioned resin interlayer is preferably a resin interlayer containing polyvinyl butyral as a main component or a resin interlayer containing ethylene vinyl acetate as a main component. Particularly, a resin interlayer containing polyvinyl butyral as a main component is preferable. The resin as a main component refers to a resin accounting for 50% by mass or more of the resin interlayer.

<Glass>

As glass used in the heat blocking glass according to the present disclosure and in the laminated glass according to the present disclosure, known glass can be used without particular limitation.

Furthermore, the shape of the glass is not particularly limited, and may be appropriately set according to the use. However, it is preferable to use flat glass.

For the laminated glass according to the present disclosure, it is preferable to use clear glass as glass on which solar radiation is to be incident and to use green glass as glass to be inside (the side opposite to the incident solar radiation, the side on which solar radiation is not incident).

Generally, the glass in the present specification contains a resin as a substitute for glass. That is, it is possible to use a molded article of a resin as a substitute for glass or a combination of glass and a molded article of a resin as a substitute for glass. Examples of the resin as a substitute for glass include a polycarbonate resin, an acrylic resin, a methacrylic resin, and the like. It is also possible to use a material obtained by coating the resin as a substitute for glass with a hardcoat layer. Examples of the hardcoat layer include an acrylic hardcoat material, a silicone-based hardcoat material, a melamine-based hardcoat material, and a material obtained by dispersing inorganic particles such as silica, titania, alumina, or zirconia in the aforementioned hardcoat materials.

The thickness of the glass is not particularly limited, and may be appropriately set as desired.

As the method for manufacturing the heat blocking glass according to the present disclosure and the method for manufacturing the laminated glass according to the present disclosure, known methods can be used without particular limitation.

It is preferable that the method for manufacturing the laminated glass according to the present disclosure includes a step of performing compression while heating the interlayer for laminated glass according to the present disclosure interposed between two sheets of glass.

For laminating glass and the heat ray-screening material according to the present invention that is interposed between glasses, for example, a method is suitable in which the heat ray-screening material and glass are preliminarily compressed in a vacuum bag and the like under reduced pressure at a temperature of 80° C. to 120° C. for 30 minutes to 60 minutes and then laminated in an oven at a temperature of 120° C. to 150° C. under a pressure of 1.0 MPa to 1.5 MPa so as to obtain laminated glass constituted with two sheets of glass and a laminate interposed therebetween. Furthermore, the heat ray-screening material and glass may be laminated using a pressure sensitive adhesive or the like.

At this time, the time for which the heat ray-screening material and glass are heated and compressed at a temperature of 120° C. to 150° C. under a pressure of 1.0 MPa to 1.5 MPa is preferably 20 minutes to 90 minutes.

The way the laminated glass is left to cool after heating and compression is not particularly limited. The laminated glass may be obtained by being left cool in a state where the pressure is being appropriately released. In the present disclosure, from the viewpoint of further improving wrinkles or cracks of the obtained laminated glass, it is preferable to reduce the temperature while maintaining the pressure after the heating and compression. To reduce the temperature while maintaining the pressure means that the temperature is reduced such that the internal pressure of the device at the time of heating and compression (preferably at a temperature of 130° C.) is reduced and becomes 75% to 100% of the internal pressure of the device at the time of heating and compression at 40° C. The method for reducing the temperature while maintaining the pressure is not particularly limited as long as the pressure is within the above range at a point in time when the temperature is reduced to 40° C. However, it is preferable to adopt an aspect in which the temperature is reduced without releasing the internal pressure of the device such that the internal pressure of the pressure device is naturally reduced as the temperature is reduced, and an aspect in which the temperature is reduced in a state where pressure is further applied from the outside such that the internal pressure of the device is reduced as the temperature is reduced. In a case where the temperature is reduced while maintaining the pressure, it is preferable that the heating and compression are performed at a temperature of 120° C. to 150° C. and then the laminated glass is left to cool down to 40° C. for 1 hour to 5 hours.

In the present disclosure, after the temperature is reduced while maintaining the pressure, it is preferable to perform a step of releasing pressure. Specifically, after the temperature is reduced while maintaining the pressure, it is preferable to reduce the temperature by releasing the pressure after the internal temperature of an autoclave becomes 40° C.

As described above, it is preferable that the method for manufacturing the laminated glass according to the present disclosure includes a step of interposing the heat ray-screening material according to the present disclosure between at least two sheets of glass, a step of then heating and compressing the laminate at a temperature of 120° C. to 150° C. under a pressure of 1.0 MPa to 1.5 MPa, a step of reducing the temperature while maintaining the pressure, and a step of releasing the pressure.

The interlayer for laminated glass according to the present disclosure may be thermally compressed on the entirety of one surface of the glass described above or only on the peripheral portion of the glass described above. In a case where the laminated glass is thermally compressed on the peripheral portion, the occurrence of wrinkles can be further inhibited.

FIG. 3 shows an example of the heat ray-screening material according to the present disclosure. It goes without saying that the present invention is not limited thereto.

FIG. 3 is a schematic cross-sectional view showing an example of the heat ray-screening material according to the present disclosure.

In a heat ray-screening material 10 shown in FIG. 3, a metal flat plate particle-containing layer 1 (12), a dielectric layer 14, a metal flat plate particle-containing layer 2 (16), and an ultraviolet absorbing layer 18 are provided in this order on a substrate 24.

Any of the metal flat plate particle-containing layer 1. (12) and the metal flat plate particle-containing layer 2 (16) may be the metal flat plate particle-containing layer A or the metal flat plate particle-containing layer B. In a case where a solar radiation incoming direction L is as shown in FIG. 3, from the viewpoint of heat blocking performance, it is preferable that the metal flat plate particle-containing layer 1 (12) is the metal flat plate particle-containing layer A and the metal flat plate particle-containing layer 2 (16) is the metal flat plate particle-containing layer B.

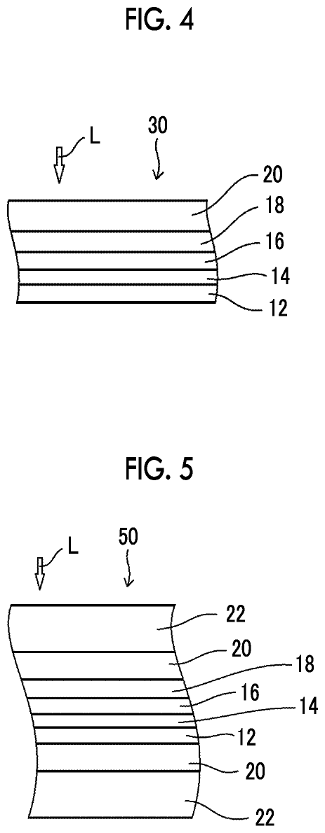

FIG. 4 shows an example of the interlayer for laminated glass according to the present disclosure. It goes without saying that the present invention is not limited thereto.

FIG. 4 is a schematic cross-sectional view showing an example of the interlayer for laminated glass according to the present disclosure.

In an interlayer for laminated glass 30 shown in FIG. 4, the metal flat plate particle-containing layer 1 (12), the dielectric layer 14, the metal flat plate particle-containing layer 2 (16), the ultraviolet absorbing layer 18, and an interlayer 20 are provided in this order.

Furthermore, for example, an aspect is also preferable in which one more interlayer 20 is provided on the outside of the metal flat plate particle-containing layer 1 (12).

FIG. 5 to FIG. 7 show an example of the laminated glass according to the present disclosure. It goes without saying that the present invention is not limited thereto.

FIG. 5 is a schematic cross-sectional view showing an example of the laminated glass according to the present disclosure.

In laminated glass 50 shown in FIG. 5, the metal flat plate particle-containing layer 1 (12), the dielectric layer 14, the metal flat plate particle-containing layer 2 (16), and the ultraviolet absorbing layer 18 are provided in this order. The interlayer 20 and glass 22 are provided in this order on the outside of the metal flat plate particle-containing layer 1 (12) and on the outside of the ultraviolet absorbing layer 18.

Any of the metal flat plate particle-containing layer 1 (12) and the metal flat plate particle-containing layer 2 (16) may be the metal flat plate particle-containing layer A or the metal flat plate particle-containing layer B. In a case where the solar radiation incoming direction L is as shown in FIG. 5, from the viewpoint of heat blocking performance, it is preferable that the metal flat plate particle-containing layer 1 (12) is the metal flat plate particle-containing layer A and the metal flat plate particle-containing layer 2 (16) is the metal flat plate particle-containing layer B.

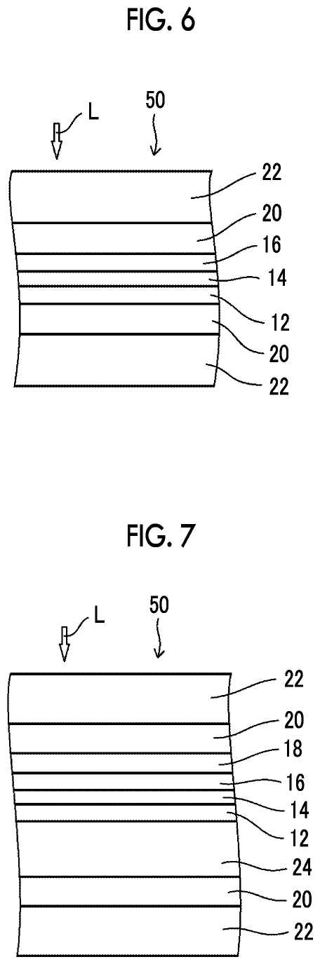

FIG. 6 is a schematic cross-sectional view showing another example of the laminated glass according to the present disclosure.

The laminated glass 50 shown in FIG. 6 is in an aspect in which the ultraviolet absorbing layer 18 is removed from the laminated glass 50 shown in FIG. 5.

FIG. 7 is a schematic cross-sectional view showing still another example of the laminated glass according to the present disclosure.

The laminated glass 50 shown in FIG. 7 is in an aspect in which the laminated glass 50 shown in FIG. 5 further has a substrate 24 between the interlayer 20 and the metal flat plate particle-containing layer 1 (12).

### EXAMPLES

Hereinafter, the present disclosure will be more specifically described based on examples, but the present disclosure is not limited to the following examples as long as the gist of the present disclosure is maintained. Unless otherwise specified, “part” and “%” are based on mass.

### Example 1

By using a wire bar, a polyethylene terephthalate (PET) film was coated with B-1 solution prepared according to the following formulation in such an amount that B-1 formed a layer having an average thickness of 30 nm after drying. Then, the coating solution was heated for 1 minute at 130° C., dried, and solidified, thereby forming a metal flat plate particle-containing layer 1.

—Preparation of Silver Nanodisk Dispersion Liquid b2—

1. Preparation of Silver Nanodisk Dispersion Liquid b1

First, a silver nanodisk dispersion liquid b1 was prepared.

Deionized water (13 L (liters)) was weighed and put into a reaction container made of NTKR-4 (stainless steel, manufactured by NIPPON STEEL NISSHIN CO., LTD.). By using a chamber comprising an agitator, which was obtained by mounting four propellers made of NTKR-4 and four paddles made of NTKR-4 on a shaft made of stainless steel (SUS316L), the deionized water was stirred at a stirring speed of 400 rpm (revolutions per min: revolution/min), and in this state, 1.0 L of an aqueous trisodium citrate (anhydrous) solution at 10 g/L was added thereto, and the resulting solution was kept at 35° C. An aqueous polystyrene sulfonate solution (0.68 L) at 8.0 g/L was added thereto, and 0.041 L of an aqueous sodium borohydride solution whose concentration was adjusted to be 23 g/L by using a 0.04 mol/L aqueous sodium hydroxide solution was further added thereto. Then, 13 L of an aqueous silver nitrate solution at 0.10 g/L was added thereto at 5.0 L/min.

Thereafter, 1.0 L of an aqueous trisodium citrate (anhydrous) solution at 10 g/L and 11 L of deionized water were added thereto, and 0.68 L of an aqueous potassium hydroquinone sulfonate solution at 80 g/L was further added thereto. The stirring speed was increased to 800 rpm, 8.1 L of an aqueous silver nitrate solution at 0.10 g/L was added thereto at 0.95 L/min, and the resulting solution was cooled to 30° C.

Subsequently, 8.0 L of an aqueous methyl hydroquinone solution at 44 g/L was added, and then the entirety of the aqueous gelatin solution at 40° C. that will be described later was added thereto. The stirring speed was increased to 1,200 rpm, and the entirety of a mixed liquid of white precipitates of silver sulfite that will be described later was added thereto.

At the stage where the pH of the prepared liquid stopped changing, 5.0 L of an aqueous NaOH solution at 1 mol/L was added thereto at 0.33 L/min. Then, 0.18 L of an aqueous solution of sodium 1-(m-sulfophenyl)-5-mercaptotetrazol at 2.0 g/L (aqueous solution in which NaOH and citric acid (anhydrous) were dissolved to adjust the pH within a range of 7.0±1.0) was added thereto, and 0.078 L of an aqueous solution of 1,2-benzisothiazolin-3-one at 70 g/L (aqueous solution adjusted to be alkaline by using an aqueous NaOH solution) was further added thereto. In this way, the silver nanodisk dispersion liquid b1 was prepared.

2. Preparation of Aqueous Gelatin Solution

Deionized water (16.7 L) was weighed and put into a dissolution tank made of SUS316L. In a state where the deionized water was being stirred at a low speed with an agitator made of SUS316L, 1.4 kg of alkali-treated cow bone gelatin (weight-average molecular weight measured by GPC: 200,000) having undergone a deionization treatment was added thereto.

Furthermore, 0.91 kg of alkali-treated cow bone gelatin (weight-average molecular weight measured by GPC: 210,000) having undergone a deionization treatment, a protease treatment, and an oxidation treatment by hydrogen peroxide was added thereto. Then, the resulting mixture was heated to 40° C., and swelling and dissolution of the gelatin were simultaneously performed so as to thoroughly dissolve the gelatin, thereby obtaining an aqueous gelatin solution used for preparing the silver nanodisk dispersion liquid b1 described above.

3. Preparation of Mixed Liquid of White Precipitates of Silver Sulfite

Deionized water (8.2 L) was weighed and put into a dissolution tank made of SUS316L, and 8.2 L of an aqueous silver nitrate solution at 100 g/L was added thereto. In a state where the deionized water was being stirred at a high speed with an agitator made of SUS316L, 2.7 L of an aqueous sodium sulfite solution at 140 g/L was added thereto for a short time, thereby preparing a mixed liquid containing white precipitates of silver sulfite, that is, a mixed liquid of white precipitates of silver sulfite used for preparing the silver nanodisk dispersion liquid b1l described above. The mixed liquid of white precipitates of silver sulfite was prepared immediately before use.

4. Preparation of Silver Nanodisk Dispersion Liquid b2

The silver nanodisk dispersion liquid b1 (800 g) obtained as above was put into a centrifuge tube, and by using at least one of the NaOH at 1 mol/L or the sulfuric acid at 0.5 mol/L, the pH of the liquid at 25° C. was adjusted to be within a range of 9.2±0.2.

By using a centrifuge (manufactured by Hitachi, LTD., himac CR22GIII, angle rotor R9A), the temperature of the liquid was set to be 35° C., the liquid was subjected to centrifugation for 60 minutes at 9,000 rpm, and then 784 g of supernatant liquid was separated and removed. An aqueous NaOH solution at 0.2 mmol/L was added to the precipitated silver nanodisks such that the total amount thereof became 400 g, and the mixture was manually stirred using a stirring rod, thereby obtaining a crude dispersion liquid.

By the same operation as described above, 24 crude dispersion liquid samples were prepared in an amount of 9,600 g in total and mixed together by being put into a tank made of SUS316L.

Furthermore, 10 ml (milliliters) of a solution of Pluronic 31 R1 (manufactured by BASF SE) at 10 g/L (diluted with a mixed liquid of methanol:deonize water=1:1 (volume ratio)) was added thereto.

By using an AUTOMIXER 20 (including a homomixer MARKII as a stirring portion) manufactured by PRIMIX Corporation, a batch dispersion treatment was performed on the mixture of the crude dispersion liquid and the solution of Pluronic 31R1 in the tank for 120 minutes at 9,000 rpm. The temperature of the liquid that was being dispersed was kept at 50° C. After being dispersed, the liquid was cooled to 25° C. and then subjected to single pass filtration by using a PROFILE II filter (manufactured by Pall Corporation Japan, product model: MCY1001Y030H13), thereby obtaining a silver nanodisk dispersion liquid b2.

That is, by performing a desalting treatment and a redispersion treatment on the prepared silver nanodisk dispersion liquid b1 according to the procedure described above, the silver nanodisk dispersion liquid b2 (dispersion liquid b2 shown in Table 1) was prepared.

TABLE 1
coating solution for forming metal flat plate particle-
containing layer 1 (B-1 dispersion liquid)

| | | Content |
|---|---|---|
| | | (parts by |
| component | trade name | mass) |
| Binder | HYDRAN (registered trademark) HW-350 | 0.2 |
| | (manufactured by DIC Corporation, | |
| | solid contents: 30% by mass) | |
| Surfactant | RAPISOL (registered trademark) A-90 | 0.4 |
| | (manufactured by NOF CORPORATION, | |
| | solid contents: 1% by mass) | |
| Surfactant | NAROACTY (registered trademark) | 0.4 |
| | CL-95 (manufactured by Sanyo | |
| | Chemical Industries, Ltd., solid | |
| | contents: 1% by mass) | |
| Solvent | Water | 67.9 |
| Solvent | Ethanol | 6.0 |
| | (manufactured by Wako Pure Chemical | |
| | Industries, Ltd. | |
| Silver nanodisk | Dispersion liquid b2 | 25.1 |
| dispersion liquid | | |
| | Total | 100.0 |

The components in Table 1 are additionally described below.
HYDRAN HW-350: polyester-based polyurethane resin
RAPISOL A-90: anionic surfactant
NAROACTY CL-95: nonionic surfactant (polyoxyalkylene ether)

By using a wire bar, the metal flat plate particle-containing layer 1 obtained as above was coated with C-1 solution shown in Table 2 in such an amount that C-1 formed a layer having an average thickness of 90 nm after drying. Then, the coating solution was heated for 1 minute at 130° C., dried, and solidified, thereby forming a dielectric layer.

TABLE 2
Coating solution for forming dielectric layer (C-1 solution)

| | | Content |
|---|---|---|
| | | (parts by |
| Component | Trade name | mass) |
| Solvent | Water | 93.5 |
| Crosslinking | CARBODILITE V-02-DL | 0.9 |
| agent | (manufactured by Nisshinbo Chemical | |
| | Inc., solid contents: 20% by mass) | |
| Binder | AS-563A | 0.3 |
| | (manufactured by Daicel FineChem Ltd., | |
| | solid contents: 27.5% by mass) | |
| Surfactant | RAPISOL (registered trademark) A-90 | 0.7 |
| | (manufactured by NOF CORPORATION, | |
| | solid contents: 1% by mass) | |
| Surfactant | NAROACTY (registered trademark) CL-95 | 0.9 |
| | (manufactured by Sanyo Chemical | |
| | Industries, Ltd., solid contents: | |
| | 1% by mass) | |
| Binder | OLESTER UD350 | 2.3 |
| | (manufactured by Mitsui Chemicals, | |
| | Inc., solid contents: 38% by mass) | |
| Lubricant | SELOSOL 524F | 1.6 |
| | (manufactured by CHUKYO YUSHI CO., | |
| | LTD., solid contents: 3% by mass) | |
| | Total | 100.0 |

The components in Table 2 other than those described above are additionally described below.
CARBODILITE V-02-L2: polycarbodiimide crosslinking agent
AS-563A: acrylic emulsion
OLESTER UD350: urethane resin

By using a wire bar, the dielectric layer was coated with A-1 solution prepared according to the following formulation in such an amount that A-1 formed a layer having an average thickness of 30 nm after drying. Then, the coating solution was heated for 1 minute at 130° C., dried, and solidified, thereby forming a metal flat plate particle-containing layer 2.

—Preparation of Silver Nanodisk Dispersion Liquid a2—

1. Preparation of Silver Nanodisk Dispersion Liquid a1

First, a silver nanodisk dispersion liquid a1 was prepared.

Deionized water (1.3 L (liters)) was weighed and put into a reaction container made of NTKR-4 (stainless steel, manufactured by NIPPON STEEL NISSHIN CO., LTD.). By using a chamber comprising an agitator, which was obtained by mounting four propellers made of NTKR-4 and four paddles made of NTKR-4 on a shaft made of stainless steel (SUS316L), the deionized water was stirred at a stirring speed of 400 rpm (revolutions per min: revolution/min), and in this state, 0.1 L of an aqueous trisodium citrate (anhydrous) solution at 10 g/L was added thereto, and the resulting solution was kept at 35° C. An aqueous polystyrene sulfonate solution (0.068 L) at a concentration of 8.0 g/L was added thereto, and 0.0041 L of an aqueous sodium borohydride solution whose concentration was adjusted to be 23 g/L by using a 0.04 mol/L aqueous sodium hydroxide solution was further added thereto. Then, 1.3 L of an aqueous silver nitrate solution at 0.10 g/L was added thereto at 5.0 L/min.

Thereafter, 1.0 L of an aqueous trisodium citrate (anhydrous) solution at 10 g/L and 11 L of deionized water were added thereto, and 0.68 L of an aqueous potassium hydroquinone sulfonate solution at 80 g/L was further added thereto. The stirring speed was increased to 800 rpm, 8.1 L of an aqueous silver nitrate solution at 0.10 g/L was added thereto at 0.95 L/min, and then the resulting solution was cooled to 30° C.

Subsequently, 8.0 L of an aqueous methyl hydroquinone solution at 44 g/L was added thereto, and then the entirety of the aqueous gelatin solution at 40° C. that will be described later was added thereto. The stirring speed was increased to 1,200 rpm, and the entirety of the mixed liquid of white precipitates of silver sulfite that will be described later was added thereto.

At the stage where the pH of the prepared liquid stopped changing, 5.0 L of an aqueous NaOH solution at 1 mol/L was added thereto at 0.33 L/min. Then, 0.18 L of an aqueous solution of sodium 1-(m-sulfophenyl)-5-mercaptotetrazol at 2.0 g/L (aqueous solution in which NaOH and citric acid (anhydrous) were dissolved to adjust the pH within a range of 7.0±1.0) was added thereto, and 0.078 L of an aqueous solution of 1,2-benzisothiazolin-3-one at 70 g/L (aqueous solution adjusted to be alkaline by using an aqueous NaOH solution) was further added thereto. In this way, the silver nanodisk dispersion liquid a1 was prepared.

2. Preparation of Aqueous Gelatin Solution

Deionized water (16.7 L) was weighed and put into a dissolution tank made of SUS316L. In a state where the deionized water was being stirred at a low speed with an agitator made of SUS316L, 2.1 kg of alkali-treated cow bone gelatin (weight-average molecular weight measured by GPC: 200,000) having undergone a deionization treatment was added thereto.

Furthermore, 1.4 kg of alkali-treated cow bone gelatin (weight-average molecular weight measured by GPC: 21,000) having undergone a deionization treatment, a protease treatment, and an oxidation treatment by hydrogen peroxide was added thereto. Then, the resulting mixture was heated to 40° C., and swelling and dissolution of the gelatin were simultaneously performed so as to thoroughly dissolve the gelatin, thereby obtaining an aqueous gelatin solution used for preparing the silver nanodisk dispersion liquid a1 described above.

3. Preparation of Mixed Liquid of White Precipitates of Silver Sulfite

Deionized water (8.2 L) was weighed and put into a dissolution tank made of SUS316L, and 8.2 L of an aqueous silver nitrate solution at 100 g/L was added thereto. In a state where the deionized water was being stirred at a high speed with an agitator made of SUS316L, 2.7 L of an aqueous sodium sulfite solution at 140 g/L was added thereto for a short time, thereby preparing a mixed liquid containing white precipitates of silver sulfite, that is, a mixed liquid of white precipitates of silver sulfite used for preparing the silver nanodisk dispersion liquid a1 described above. The mixed liquid of white precipitates of silver sulfite was prepared immediately before use.

4. Preparation of Silver Nanodisk Dispersion Liquid a2

A silver nanodisk dispersion liquid a2 was prepared in the same manner as that adopted for preparing the dispersion liquid b2, except that the silver nanodisk dispersion liquid a1 was used instead of the silver nanodisk b1.

TABLE 3
Coating solution for forming metal flat plate particle-
containing layer 2 (A-1 dispersion liquid)

| | | Content |
|---|---|---|
| | | (parts by |
| Component | Trade name | mass) |
| Binder | HYDRAN (registered trademark) HW-350 | 0.2 |
| | (manufactured by DIC Corporation, | |
| | solid contents: 30% by mass) | |
| Surfactant | RAPISOL (registered trademark) A-90 | 0.4 |
| | (manufactured by NOF CORPORATION, | |
| | solid contents: 1% by mass) | |
| Surfactant | NAROACTY (registered trademark) | 0.4 |
| | CL-95 (manufactured by Sanyo | |
| | Chemical Industries, Ltd., solid | |
| | contents: 1% by mass) | |
| Solvent | Water | 67.9 |
| Solvent | Ethanol | 6.0 |
| | (manufactured by Wako Pure | |
| | Chemical Industries, Ltd.) | |
| Silver nanodisk | Dispersion liquid a2 | 25.1 |
| dispersion liquid | | |
| | Total | 100.0 |

By using a wire bar, the metal flat plate particle-containing layer 2 obtained as above was coated with D-1 solution described below in such an amount that D-1 formed a layer having an average thickness equal to or smaller than 1,000 nm after drying. Then, the coating solution was heated for 1 minute at 130° C., dried, and solidified, thereby forming an ultraviolet (UV) absorbing layer.

TABLE 4
Coating solution for forming ultraviolet
absorbing layer (D-1 solution)

| | | Content |
|---|---|---|
| | | (parts by |
| Component | Trade name | mass) |
| Solvent | Water | 86.7 |
| Crosslinking | CARBODILITE V-02-DL | 1.1 |
| agent | (manufactured by Nisshinbo Chemical | |
| | Inc., solid contents: 20% by mass) | |
| Binder | AS-563A | 0.3 |
| | (manufactured by Daicel FineChem Ltd., | |
| | solid contents: 27.5% by mass) | |
| Surfactant | RAPISOL (registered trademark) A-90 | 1.5 |
| | (manufactured by NOF CORPORATION, | |
| | solid contents: 1% by mass) | |
| Surfactant | NAROACTY (registered trademark) | 2.1 |
| | CL-95 (manufactured by Sanyo | |
| | Chemical Industries, Ltd., solid | |
| | contents: 1% by mass) | |
| Binder | TAKELAC WS5100 | 3.5 |
| | (manufactured by Mitsui Chemicals, | |
| | Inc., solid contents: 30% by mass) | |
| Ultraviolet | Compound A | 4.8 |
| absorber | Tinuvin 477DW | |
| | (manufactured by BASF SE, solid | |
| | contents: 40% by mass) | |
| | Total | 100.0 |

The components shown in Table 4 other than the components described above are additionally described below.
Tinuvin 477DW: triazine-based ultraviolet absorber, the following compound

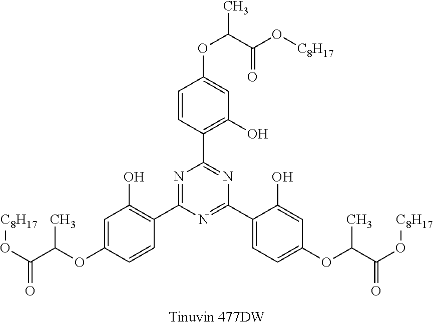

—Transfer to Interlayer for Laminated Glass—

Then, the prepared film, a polyvinyl butyral interlayer for laminated glass (thickness: 0.38 mm, softening point: 130° C., manufactured by SEKISUI CHEMICAL CO., LTD.) with surfaces having undergone an embossing treatment, and a glass substrate having a thickness of 2 mm (manufactured by Corning Incorporated., clear glass) were stacked such that the glass substrate, the interlayer for laminated glass, and the prepared film (heat ray-screening material) were laminated in this order. By using a laminator (manufactured by Taisei Laminator Co., LTD.), the heat ray-screening material and the polyvinyl butyral interlayer were thermally bonded to each other. At this time, the temperature of the laminator rollers was 120° C., the nit pressure was 0.2 MPa, and the transport speed was 0.15 m/min. Immediately after the thermal bonding, the PET film was peeled from the laminate, thereby preparing an interlayer laminate formed of a heat ray-screening material, an interlayer for laminated glass, and a glass substrate.

<Making Laminated Glass>

—Preliminary Compression—

On the heat ray-screening material of each of the prepared interlayer laminates, the interlayer for laminated glass and the glass substrate were stacked. The resulting material was put into a rubber bag, and the internal pressure of the rubber bag was reduced using a vacuum pump. Then, the material was heated to 90° C. under reduced pressure and kept as it was for 30 minutes, and then the temperature and the pressure were restored to normal temperature and normal pressure to finish a preliminary compression step.

—Permanent Compression—

In an autoclave, each of the laminated glass having undergone preliminary compression was kept as it was for 20 minutes under the condition of a pressure of 1.3 MPa and a temperature of 120° C., and then the temperature and the pressure were restored to normal temperature and normal pressure (25° C. and 1 atm) to finish a permanent compression step.

### Examples 2 to 8, Comparative Examples 1 and 2, and Reference Examples 1 to 4

Heat ray-screening materials and laminated glass were prepared in the same manner as in Example 1, except that whether or not each layer is formed, the material and the thickness of each layer, the type of the metal flat plate particles, and the amount of the metal flat plate particles used were changed as described in Table 5 or Table 6. In Example 6, laminated glass was not prepared.

The laminated glass obtained in Examples 1 to 5 was the laminated glass shown in FIG. 5.

<Evaluation of Metal Flat Plate Particles>

—Average Equivalent Circular Diameter of Metal Flat Plate Particles—

For 200 particles randomly extracted from an image of metal flat plate particles observed with SEM, image analysis was performed, the equivalent circular diameter of the particles was calculated, and the average thereof was adopted as the average equivalent circular diameter of the metal flat plate particles.

—Average Thickness—

The obtained dispersion liquid containing silver flat plate particles was added dropwise to a glass substrate, and the thickness of one silver flat plate particle was measured using an atomic force microscope (AFM) (Nanocute II, manufactured by Seiko Instruments Inc.). The thickness of the particle was measured using AFM and a self-detection type sensor under the condition of a DFM mode, a measurement range of 5 μm, a scanning speed of 180 sec/i frame, and number of datapoints of 256×256.

—Aspect Ratio—

Based on the obtained average equivalent circular diameter and the average thickness of the silver flat plat particles, the average equivalent circular diameter was divided by the average thickness, thereby calculating an aspect ratio.

—Areal Density—

A layer containing metal flat plate particles was formed by coating and dried. Then, the surface of the layer was observed and imaged using an S4300 scanning electron microscope manufactured by Hitachi, Ltd., and the proportion of a projected area of the metal flat plat particles in unit area was adopted as an areal density.

—Thickness of Dielectric Layer (Distance Between Two Layers)—

By ion milling processing of irradiating a sample with argon ion beams, the heat ray-screening material of Example 1 was cleaved, thereby preparing a vertical cross section sample of the heat ray-screening material. By observing the vertical cross section sample with a scanning electron microscope (SEM), a thickness d (nm) of the dielectric layer was determined.

<Visible Ray Transmittance, Maximum Reflection Wavelength, and Reflectance>

By the method described in JIS R3106:1998 “Testing Method on Transmittance Reflectance and Emittance of Flat Glasses and Evaluation of Solar Heat Gain Coefficient”, a visible ray transmittance and a reflectance were measured in a wavelength range of 300 nm to 2,100 nm. The visible ray transmittance and the reflectance were calculated from the measurement results according to JIS-R3106. At this time, the metal flat plate particle-containing layer 1 was adopted as the side of incidence rays.

Furthermore, from the optical reflection spectrum obtained from the measurement results, a wavelength for maximum reflection was determined and adopted as a maximum reflection wavelength.

<Total Solar Energy Transmitted Through a Glazing (TTS)>

For each of the laminated glass, the heat ray-screening material, and the interlayer for laminated glass, TTS was calculated by the method described in ISO13837. The smaller the value of TTS, the better the heat blocking performance.

TABLE 5

| | | | Metal flat plate particle layer 2 | | | | | |
|---|---|---|---|---|---|---|---|---|
| | | | First layer (solar radiation incidence side) | | | | | |
| | Ultraviolet absorbing | | | | | Maximum | | |
| | layer | | Particle | | | reflection | | |
| | Thickness | Ultraviolet | diameter | Thickness | Aspect | wavelength | Areal | Dielectric layer |
| | (nm) | absorber | (nm) | (nm) | ratio | (nm) | density | m |
| Example 1 | 1,000 | Compound A | 200 | 5 | 40 | 1,500 | 65 | 0 |
| Example 2 | 1,000 | Compound A | 200 | 5 | 40 | 1,500 | 40 | 0 |
| Example 3 | 1,000 | Compound A | 200 | 5 | 40 | 1,500 | 40 | 0 |
| Example 4 | 1,000 | Compound A | 200 | 5 | 40 | 1,500 | 60 | 0 |
| Example 5 | 1,000 | Compound A | 200 | 5 | 40 | 1,500 | 45 | 0 |
| Example 6 | 1,000 | Compound A | 200 | 5 | 56 | 1,500 | 60 | 0 |
| Example 7 | 1,000 | Compound A | 200 | 5 | 40 | 1,500 | 65 | 0 |
| Example 8 | 1,000 | Compound A | 200 | 5 | 40 | 1,500 | 45 | 0 |

| | | Metal flat plate particle layer 1 | | | | |
|---|---|---|---|---|---|---|
| | | Second layer (side on which solar radiation is not | | | | |
| | | incident) | | | | |
| | | | | | Maximum | |
| | Dielectric layer | Particle | | | reflection | |
| | Thickness | diameter | Thickness | Aspect | wavelength | Areal |
| | (nm) | (nm) | (nm) | ratio | (nm) | density |
| Example 1 | 90 | 110 | 7.5 | 14.7 | 1,000 | 60 |
| Example 2 | 90 | 110 | 7.5 | 14.7 | 1,000 | 40 |
| Example 3 | 90 | 110 | 7.5 | 14.7 | 1,000 | 40 |
| Example 4 | 90 | 110 | 7.5 | 14.7 | 1,000 | 60 |
| Example 5 | 90 | 110 | 7.5 | 14.7 | 1,000 | 45 |
| Example 6 | 90 | 110 | 7.5 | 14.7 | 1,000 | 60 |
| Example 7 | 90 | 110 | 7.5 | 14.7 | 1,000 | 60 |
| Example 8 | 90 | 110 | 7.5 | 14.7 | 1,000 | 45 |

| | |
|---|---|
| Glass | Performance |

| | Substrate | | | | Side on which | Visible ray | |
|---|---|---|---|---|---|---|---|
| | | Thickness | Interlayer | Solar radiation | solar radiation | transmittance | TTS |
| | Material | (μm) | Material | incidence side | is not incident | (%) | (%) |
| Example 1 | N/A | N/A | PVB | Clear glass | Clear glass | 73 | 49 |
| Example 2 | N/A | N/A | ITO-containing PVB | Clear glass | Clear glass | 72 | 50 |
| Example 3 | N/A | N/A | ITO-containing PVB | Clear glass | Green glass | 70 | 46 |
| Example 4 | N/A | N/A | PVB | Clear glass | Clear glass | 74 | 50 |
| Example 5 | N/A | N/A | PVB | Clear glass | Green glass | 71 | 49 |
| Example 6 | N/A | N/A | PVB | Clear glass | Clear glass | 74 | 50 |
| Example 7 | PET | 63 | N/A | N/A | N/A | 73 | 49 |
| Example 8 | PET | 63 | PVB | Clear glass | Green glass | 70 | 48 |

TABLE 6

| | | | Metal flat plate particle layer 2 | | | | | |
|---|---|---|---|---|---|---|---|---|
| | | | First layer (solar radiation incidence side) | | | | | |
| | Ultraviolet absorbing | | | | | Maximum | | |
| | layer | | Particle | | | reflection | | |
| | Thickness | Ultraviolet | diameter | Thickness | Aspect | wavelength | Areal | Dielectric layer |
| | (nm) | absorber | (nm) | (nm) | ratio | (nm) | density | m |
| Comparative | 1,000 | Compound A | 170 | 10 | 17 | 1,100 | 41 | 0 |
| Example 1 | | | | | | | | |
| Comparative | 1,000 | Compound A | 110 | 7.5 | 14.7 | 1,000 | 44 | 0 |
| Example 2 | | | | | | | | |
| Reference | N/A | N/A | — | — | — | — | — | — |
| Example 1 | | | | | | | | |
| Reference | N/A | N/A | — | — | — | — | — | — |
| Example 2 | | | | | | | | |
| Reference | N/A | N/A | — | — | — | — | — | — |
| Example 3 | | | | | | | | |
| Reference | N/A | N/A | — | — | — | — | — | — |
| Example 4 | | | | | | | | |

| | | Metal flat plate particle layer 1 | | | | |
|---|---|---|---|---|---|---|
| | | Second layer (side on which solar radiation is not incident) | | | | |
| | | | | | Maximum | |
| | Dielectric layer | Particle | | | reflection | |
| | Thickness | diameter | Thickness | Aspect | wavelength | Areal |
| | (nm) | (nm) | (nm) | ratio | (nm) | density |
| Comparative | 90 | 115 | 10 | 11.5 | 900 | 41 |
| Example 1 | | | | | | |
| Comparative | 90 | 110 | 7.5 | 14.7 | 1,000 | 44 |
| Example 2 | | | | | | |
| Reference | 700 | 110 | 7.5 | 14.7 | 1,000 | 44 |
| Example 1 | | | | | | |
| Reference | 700 | 110 | 7.5 | 14.7 | 1,000 | 30 |
| Example 2 | | | | | | |
| Reference | 700 | 110 | 7.5 | 14.7 | 1,000 | 12 |
| Example 3 | | | | | | |
| Reference | 700 | 110 | 7.5 | 14.7 | 1,000 | 30 |
| Example 4 | | | | | | |

| | | | | Glass | | Performance | |
|---|---|---|---|---|---|---|---|
| | Substrate | | | | Side on which | Visible ray | |
| | | Thickness | Interlayer | Solar radiation | solar radiation is | transmittance | TTS |
| | Material | (μm) | Material | incidence side | not incident | (%) | (%) |
| Comparative | N/A | — | PVB | Clear glass | Clear glass | 71 | 52 |
| Example 1 | | | | | | | |
| Comparative | N/A | — | PVB | Clear glass | Clear glass | 77 | 60 |
| Example 2 | | | | | | | |
| Reference | PET | 63 | PVB | Clear glass | Clear glass | 73 | 57 |
| Example 1 | | | | | | | |
| Reference | PET | 63 | PVB | Clear glass | Clear glass | 76 | 62 |
| Example 2 | | | | | | | |
| Reference | PET | 63 | PVB | Clear glass | Clear glass | 80 | 67 |
| Example 3 | | | | | | | |
| Reference | PET | 63 | PVB | Clear glass | Green glass | 70 | 55 |
| Example 4 | | | | | | | |

“Particle diameter” for each of the metal flat plate particle-containing layers described in Table 5 and Table 6 is the average equivalent circular diameter of the metal flat plate particles contained in the layers, “thickness” for each of the metal flat plate particle-containing layers is the average thickness of the metal flat plate particles contained in the layers, and the unit of “areal density” for each of the metal flat plate particle-containing layers is % by area.

For all of the heat ray-screening materials of Examples 1 to 8, λ1 is 550 nm. Furthermore, all of the heat ray-screening materials of Examples 1 to 8 satisfy Formula 1 described above.

The following is the materials or raw materials listed in Table 5 or Table 6 that are used in addition to the aforementioned materials and will be described later.

ITO-containing PVB: S-LEC Solar Control Film manufactured by SEKISUI CHEMICAL CO., LTD.

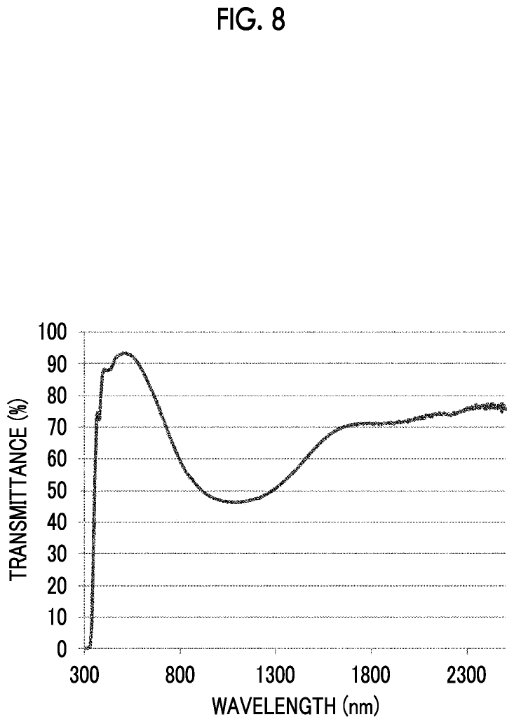

Green glass used: glass having transmission spectrum shown in FIG. 8 (glass absorbing near infrared)

Metal flat plate particles a-2: silver flat plate particles, average equivalent circular diameter: 170 nm, average thickness: 10 nm, aspect ratio: 17, prepared by the following method

Metal flat plate particles a-3: silver flat plate particles, average equivalent circular diameter: 115 nm, average thickness: 10 nm, aspect ratio: 11.5, prepared by the following method

Metal flat plate particles a-4: silver flat plate particles, average equivalent circular diameter: 178 nm, average thickness: 10.7 nm, aspect ratio: 16.6, prepared by the following method

Metal flat plate particles b-2: silver flat plate particles, average equivalent circular diameter: 280 nm, average thickness: 5 nm, aspect ratio: 56, prepared by the following method

<Preparation of Metal Flat Plate Particles a-2>

An aqueous polystyrene sulfonate solution (2.5 mL) at 0.5 g/L was added to 50 mL of a 2.5 mM aqueous sodium citrate solution, and the resulting solution was heated to 35° C. A 10 mM aqueous sodium borohydride solution (3 mL) was added to the solution, and 50 mL of a 0.5 mM aqueous silver nitrate solution was added thereto with stirring at 20 mL/min. The obtained solution was stirred for 30 minutes, thereby preparing a seed solution.

Deionized water (127.6 mL) was added to 132.7 mL of a 2.5 mM aqueous sodium citrate solution, and the resulting solution was heated to 35° C. A 10 mM aqueous ascorbic acid solution (2 mL) was added to the solution, 42.4 mL of the seed solution was added thereto, and 79.6 mL of a 0.5 mM aqueous silver nitrate solution was added thereto at 10 mL/min with stirring. After the solution was stirred for 30 minutes, 71.1 mL of a 0.35 M aqueous potassium hydroquinone sulfonate solution was added thereto, and 200 g of a 7% aqueous gelatin solution was added thereto. A mixed liquid of white precipitates, which was prepared by mixing 107 mL of a 0.25 M aqueous sodium sulfite solution with 107 mL of a 0.47 M aqueous silver nitrate solution, was added to the solution. Immediately after the mixed liquid of white precipitates was added, 72 mL of a 0.08 M aqueous NaOH solution was added thereto. At this time, in order that the pH became higher than 10, the aqueous NaOH solution was added in a state of controlling the addition speed. The resulting solution was stirred for 300 minutes, thereby obtaining a dispersion liquid of silver flat plate particles.

It was confirmed that hexagonal flat plate particles of silver (hereinafter, referred to as silver hexagonal flat plate particles) having an average equivalent circular diameter of 170 nm are generated in the dispersion liquid of silver flat plate particles. Furthermore, as a result of measuring the thickness of the silver hexagonal flat plate particles by using an atomic force microscope (Nanocute II, manufactured by Seiko Instruments Inc.), it was found that silver hexagonal flat plate particles having an average thickness of 10 nm and an aspect ratio of 17.0 are generated.

NaOH (1 mol/L, 0.75 mL) was added to 16 mL of the dispersion liquid of silver flat plate particles, and then 24 mL of deionized water was added thereto. The resulting solution was subjected to centrifugation for 5 minutes at 5,000 rpm by using a centrifuge (manufactured by KOKUSAN Co., Ltd., H-200N, angle rotor BN) such that the silver hexagonal flat plate particles were precipitated. After the centrifugation, the supernatant liquid was discarded, 6 mL of water was added to the precipitates, and the precipitated silver hexagonal flat plate particles were dispersed again. In this way, metal flat plate particles a-2 were prepared.

<Preparation of Metal Flat Plate Particles a-3>

An aqueous polystyrene sulfonate solution (2.5 mL) at 0.5 g/L was added to 50 mL of a 2.5 mM aqueous sodium citrate solution, and the resulting solution was heated to 35° C. A 10 mM aqueous sodium borohydride solution (3 mL) was added to the solution, and 50 mL of a 0.5 mM aqueous silver nitrate solution was added thereto at 20 mL/min with stirring. The obtained solution was stirred for 30 minutes, thereby preparing a seed solution.

Deionized water (127.6 mL) was added to 255.2 mL of a 2.5 mM aqueous sodium citrate solution, and the resulting solution was heated to 35° C. A 10 mM aqueous ascorbic acid solution (2 mL) was added to the solution, 42.4 mL of the seed solution was added thereto, and 79.6 mL of a 0.5 mM aqueous silver nitrate solution was added thereto at 10 mL/min with stirring. After the solution was stirred for 30 minutes, 71.1 mL of a 0.35 M aqueous potassium hydroquinone sulfonate solution was added thereto, and 200 g of a 7% aqueous gelatin solution was added thereto. A mixed liquid of white precipitates, which was prepared by mixing 107 mL of a 0.25 M aqueous sodium sulfite solution with 107 mL of a 0.47 M aqueous silver nitrate solution, was added to the solution. Immediately after the mixed liquid of white precipitates was added, 72 mL of a 0.08 M aqueous NaOH solution was added thereto. At this time, in order that the pH became higher than 10, the aqueous NaOH solution was added in a state of controlling the addition speed. The resulting solution was stirred for 300 minutes, thereby obtaining a dispersion liquid of silver flat plate particles. NaOH (1 mol/L, 0.75 mL) was added to 16 mL of the dispersion liquid of silver flat plate particles, and then 24 mL of deionized water was added thereto. The resulting solution was subjected to centrifugation for 5 minutes at 5,000 rpm by using a centrifuge (manufactured by KOKUSAN Co., Ltd., H-200N, angle rotor BN) such that the silver hexagonal flat plate particles were precipitated. After the centrifuge, the supernatant liquid was discarded, 6 mL of water was added to the precipitates, and the precipitated silver hexagonal flat plate particles were dispersed again. In this way, metal flat plate particles a-3 were prepared.

<Preparation of Metal Flat Plate Particles a-4>

—Preparation of Dispersion Liquid E1 of Metal Flat Plate Particles—

An aqueous sodium polystyrene sulfonate solution (25 mL) at 8 g/L was added to 500 mL of a 2.5 mM aqueous sodium citrate solution, and the resulting solution was heated to 35° C. A 3 mM aqueous sodium borohydride solution (30 mL) was added to the solution, and 300 mL of a 0.5 mM aqueous silver nitrate solution (Ag-1) was added thereto at 20 mL/min with stirring. The resulting solution was stirred for 30 minutes, and then 500 mL of a 2.5 mM aqueous sodium citrate solution and 25 mL of a 5.0 mM aqueous ascorbic acid solution were added thereto. Furthermore, 300 mL of a 0.5 mM aqueous silver nitrate solution (Ag-2) was added thereto at a speed of 10 mL/min with stirring. After the resulting solution was stirred for 30 minutes, 284 mL of a 0.35 M aqueous potassium hydroquinone sulfonate solution and 400 g of a 14% by mass aqueous gelatin solution were put into the reaction tank. Thereafter, a mixed liquid of white precipitates of silver nitrate, which was prepared by mixing 343 mL of a 0.305 M aqueous sodium sulfate solution with 343 mL of a 0.588 M aqueous silver nitrate solution, was added thereto. The resulting solution was stirred for 300 minutes, thereby obtaining a dispersion liquid E1 of metal flat plate particles. As a result of evaluating the average particle diameter and the average thickness of the metal particles in the obtained dispersion liquid E1 of metal flat plate particles, it was confirmed that hexagonal flat plate particles of silver (hereinafter, referred to as hexagonal silver flat plate particles) having an average equivalent circular diameter of 105 nm are generated in the dispersion liquid E1 of metal flat plate particles.

—Preparation of Dispersion Liquid E2 of Metal Flat Plate Particles—

A dispersion liquid E2 of metal flat plate particles was prepared in the same manner as that adopted for preparing the dispersion liquid E1 of metal flat plate particles, except that the amount of the 0.5 mM aqueous silver nitrate solution (Ag-1) added for preparing the dispersion liquid E1 of metal flat plate particles was changed to 75 mL. As a result of evaluating the average particle diameter and the average thickness of the metal particles in the obtained dispersion liquid E2 of metal flat plate particles, it was confirmed that hexagonal flat plate particles of silver (hereinafter, referred to as hexagonal silver flat plate particles) having an average equivalent circular diameter of 250 nm are generated in the dispersion liquid E2 of metal flat plate particles.

—Preparation of Dispersion Liquid E3 of Metal Flat Plate Particles—

By mixing together the dispersion liquid E1 of metal flat plate particles and the dispersion liquid E2 of metal flat plate particles at a mass ratio of 1:1, a dispersion liquid E3 of metal flat plate particles was obtained.

—Preparation of Metal Flat Plate Particles a-4—

The dispersion liquid E3 of metal flat plate particles (500 mL) was subjected to centrifugation for 30 minutes at 7,000 rpm by using a centrifuge (H-200N manufactured by KOKUSAN Co., Ltd., angle rotor BN) such that hexagonal silver flat plate particles were precipitated. After the centrifugation, 450 mL of the supernatant liquid was discarded, 200 mL of pure water was added thereto, and the precipitated hexagonal silver flat plate particles were dispersed again, thereby obtaining metal flat plate particles a-4.

<Preparation of Metal Flat Plate Particles b-2>

—Preparation of Silver Nanodisk Dispersion Liquid b-2—

1 Preparation of Silver Nanodisk Dispersion Liquid b-2-1

First, a silver nanodisk dispersion liquid b-2-1 was prepared.

Deionized water (0.7 L (liters)) was weighed and put into a reaction container made of NTKR-4 (stainless steel, manufactured by NIPPON STEEL NISSHIN CO., LTD.). By using a chamber comprising an agitator, which was obtained by mounting four propellers made of NTKR-4 and four paddles made of NTKR-4 on a shaft made of stainless steel (SUS316L), the deionized water was stirred at a stirring speed of 400 rpm (revolutions per min: revolution/min), and in this state, 0.05 L of an aqueous trisodium citrate (anhydrous) solution at 10 g/L was added thereto, and the resulting solution was kept at 35° C. An aqueous polystyrene sulfonate solution (0.034 L) at 8.0 g/L was added thereto, and 0.002 L of an aqueous sodium borohydride solution whose concentration was adjusted to be 23 g/L by using a 0.04 mol/L aqueous sodium hydroxide solution was further added thereto. Then, 0.7 L of an aqueous silver nitrate solution at 0.10 g/L was added thereto at 5.0 L/min.

Thereafter, 1.0 L of an aqueous trisodium citrate (anhydrous) solution at 10 g/L and 11 L of deionized water were added thereto, and 0.68 L of an aqueous potassium hydroquinone sulfonate solution at 80 g/L was further added thereto. The stirring speed was increased to 800 rpm, 8.1 L of an aqueous silver nitrate solution at 0.10 g/L was added thereto at 0.95 L/min, and then the resulting solution was cooled to 30° C.

Subsequently, 8.0 L of an aqueous methyl hydroquinone solution at 44 g/L was added thereto, and then the entirety of the aqueous gelatin solution at 40° C. that will be described later was added thereto. The stirring speed was increased to 1,200 rpm, and the entirety of the mixed liquid of white precipitates of silver sulfite that will be described later was added thereto.

At the stage where the pH of the prepared liquid stopped changing, 5.0 L of an aqueous NaOH solution at 1 mol/L was added thereto at 0.33 L/min. Then, 0.18 L of an aqueous solution of sodium 1-(m-sulfophenyl)-5-mercaptotetrazol at 2.0 g/L (aqueous solution in which NaOH and citric acid (anhydrous) were dissolved to adjust pH within a range of 7.0±1.0) was added thereto, and 0.078 L of an aqueous solution of 1,2-benzisothiazolin-3-one at 70 g/L (aqueous solution adjusted to be alkaline by using an aqueous NaOH solution) was further added thereto. In this way, a silver nanodisk dispersion liquid b-2-1 was prepared.

2. Preparation of Aqueous Gelatin Solution

Deionized water (16.7 L) was weighed and put into a dissolution tank made of SUS316L. In a state where the deionized water was being stirred at a low speed with an agitator made of SUS316L, 2.8 kg of alkali-treated cow bone gelatin (weight-average molecular weight measured by GPC: 200,000) having undergone a deionization treatment was added thereto.

Furthermore, 1.8 kg of alkali-treated cow bone gelatin (weight-average molecular weight measured by GPC: 21,000) having undergone a deionization treatment, a protease treatment, and an oxidation treatment by hydrogen peroxide was added thereto. Then, the resulting mixture was heated to 40° C., and swelling and dissolution of the gelatin were simultaneously performed so as to thoroughly dissolve the gelatin, thereby obtaining an aqueous gelatin solution used for preparing the silver nanodisk dispersion liquid b-2-1 described above.

3. Preparation of Mixed Liquid of White Precipitates of Silver Sulfite

Deionized water (8.2 L) was weighed and put into a dissolution tank made of SUS316L, and 8.2 L of an aqueous silver nitrate solution at 100 g/L was added thereto. In a state where the deionized water was being stirred at a high speed with an agitator made of SUS316L, 2.7 L of an aqueous sodium sulfite solution at 140 g/L was added thereto for a short time, thereby preparing a mixed liquid containing white precipitates of silver sulfite, that is, a mixed liquid of white precipitates of silver sulfite used for preparing the silver nanodisk dispersion liquid b-2-1 described above. The mixed liquid of white precipitates of silver sulfite was prepared immediately before use.

4. Preparation of Silver Nanodisk Dispersion Liquid b-2

A silver nanodisk dispersion liquid b-2 was prepared in the same manner as that adopted for preparing the dispersion liquid b2, except that the silver nanodisk dispersion liquid b-2-1 was used instead of the silver nanodisk b1.

<Formation of Dielectric Layer in Reference Examples 1 to 4>

In Reference Examples 1 to 4, a dielectric layer was prepared as below.

—Preparation of Coating Solution—

By mixing together components at the ratio show in the following Table 7, a coating solution was prepared.

TABLE 7
Coating solution for forming dielectric layer

| | | Content |
|---|---|---|
| | | (parts by |
| Component | Trade name | mass) |
| Solvent | Water | 35.0 |
| Crosslinking | CARBODILITE V-02-DL | 5.7 |
| agent | (manufactured by Nisshinbo Chemical | |
| | Inc., solid contents: 20% by mass) | |
| Binder | AS-563A | 1.6 |
| | (manufactured by Daicel FineChem Ltd., | |
| | solid contents: 27.5% by mass) | |
| Surfactant | RAPISOL (registered trademark) A-90 | 8.2 |
| | (manufactured by NOF CORPORATION, | |
| | solid contents: 1% by mass) | |
| Surfactant | NAROACTY (registered trademark) CL-95 | 11.4 |
| | (manufactured by Sanyo Chemical | |
| | Industries, Ltd., solid contents: | |
| | 1% by mass) | |
| Antioxidant | 1-(5-Methylureidophenyl)-5-mercapto | 19.1 |
| | tetrazol (manufactured by Wako Pure | |
| | Chemical Industries, Ltd., solid | |
| | contents: 2% by mass) | |
| Matting agent | MX80H2WT | 1.2 |
| | (manufactured by Soken Chemical & | |
| | Engineering Co., Ltd., solid | |
| | contents: 12.8%) | |
| Binder | TAKELAC WS-5100 | 17.7 |
| | (manufactured by Mitsui Chemicals, | |
| | Inc., solid contents: 30% by mass) | |
| | Total | 100.0 |

By using a wire bar, the metal flat plate particle-containing layer 1 was coated with the obtained coating solution in such an amount that the coating solution formed a layer having an average thickness of 700 nm after drying. Then, the coating solution was heated at 130° C. for 1 minute, dried, and solidified, thereby forming a dielectric layer.

As is evident from the results in Table 5 and Table 6, the heat ray-screening material according to the present disclosure has excellent heat blocking performance.

### Examples 8 to 10

<Preparation of Gold-Coated Silver Nanodisks Used in Example 9>

As Example 9, a heat ray-screening material was prepared by the same preparation method as in Example 8, except that a gold-coated nanodisk dispersion liquid a2A′ and a gold-coated nanodisk dispersion liquid b2A′ described below were used instead of the silver nanodisk dispersion liquid a2 and the silver nanodisk dispersion liquid b2 in Example 8, and laminated glass was obtained. The visible ray transmittance and TTS thereof were the same as those in Example 8.

—Preparation of Silver Nanodisk Dispersion Liquid a2A′—

An aqueous solution (2.78 L) of 0.1% by mass chloroauric acid (manufactured by Wako Pure Chemical Industries, Ltd.) was added to 50 L of the silver nanodisk dispersion liquid a2, and the resulting solution was stirred for 4 hours at 60° C., thereby obtaining a silver nanodisk dispersion liquid a2A′.

—Preparation of Silver Nanodisk Dispersion Liquid b2A′—

An aqueous solution (2.78 L) of 0.1% by mass chloroauric acid (manufactured by Wako Pure Chemical Industries, Ltd.) was added to 50 L of the silver nanodisk dispersion liquid b2, and the resulting solution was stirred for 4 hours at 60° C., thereby obtaining a silver nanodisk dispersion liquid b2A′.

<Preparation of Gold-Coated Silver Nanodisks Used in Example 10>

As Example 10, a heat ray-screening material was prepared by the same preparation method as in Example 8, except that a gold-coated nanodisk dispersion liquid a2A″ and a gold-coated nanodisk dispersion liquid b2A″ described below were used instead of the silver nanodisk dispersion liquid a2 and the silver nanodisk dispersion liquid b2 in Example 8, and laminated glass was obtained. The visible ray transmittance and TTS thereof were the same as those in Example 8.

<Preparation of Gold-Coated Silver Nanodisk Dispersion Liquid a2A″′>

A dispersion liquid of flat plate-like silver particles (144 g, silver concentration: 0.5% by mass z 46 mmol/L), which was obtained by adding 13.6 g of hexadecyltrimethyl ammonium chloride (CTAC) to 130.4 g of the silver nanodisk dispersion liquid a2, was added to the following gold coating treatment liquid F1 in a reaction container, and the resulting solution was stirred for 4 hours at 60° C., thereby obtaining a gold-coated silver nanodisk dispersion liquid a2A″.

—Preparation of Gold Coating Treatment Liquid F1—

Water (266.3 g), 177 g of 0.5 mol/L ascorbic acid (reducing agent), and 608 g of the following gold reducing liquid G1 were sequentially put into a reaction container, the resulting solution was stirred for 5 minutes, and then the pH was adjusted to be equal to or higher than 10 by using an aqueous solution of 1 mol/L sodium hydroxide, thereby obtaining a gold coating treatment liquid F1.

—Preparation of Gold Reducing Liquid G1—

Water (18.2 g), 353.6 g of 1.88 mmol/L chloroauric acid tetrahydrate (water-soluble gold compound), 15.6 g of a 0.2 mol/L sodium hydroxide (pH adjuster), and 220.6 g of a 0.1 mol/L sodium sulfate (complexing agent) were sequentially put into a container while being gently stirred, thereby obtaining a gold reducing liquid G1.

—Evaluation of Gold-Coated Silver Nanodisk Dispersion Liquid a2A″—

The gold-coated silver nanodisk dispersion liquid a2A″ was added dropwise to a PET substrate, dried, and imaged along the cross-sectional direction of the particle by using High-angle Annular Dark Field Scanning TEM (HAADF-STEM). The thickness of the gold coating layer, which was found to have high brightness in the captured image, was measured for each of the main flat surface and the end face at 5 spots in one particle by using an image analysis tool such as Image J, and the arithmetic mean of the thickness of a total of 20 particles was calculated, thereby calculating an average thickness (A) of the main flat surface, an average thickness (B) of the end face, and a ratio (A/B) of the average thickness (A) to the average thickness (B).

In the gold-coated silver nanodisks contained in the gold-coated silver nanodisk dispersion liquid a2A″, the average thickness of gold in the main flat surface was 0.7 nm, and the average thickness of gold in the end face was 1.0 nm.

<Preparation of Gold-Coated Silver Nanodisk Dispersion Liquid b2A″>

A dispersion liquid of flat plate-like silver particles (144 g, silver concentration: 0.5% by mass≈46 mmol/L), which was obtained by adding 13.6 g of hexadecyltrimethyl ammonium chloride (CTAC) to 130.4 g of the silver nanodisk dispersion liquid b2, was added to the following gold coating treatment liquid F1 in a reaction container, and the resulting solution was stirred for 4 hours at 60° C., thereby obtaining a gold-coated silver nanodisk dispersion liquid b2A″.

<Evaluation of Heat Blocking Performance after Test for Hot Weather Fastness>

The laminated glass obtained in Examples 8 to 10 was stored for 96 hours at a temperature of 85° C. and a humidity of 50% RH in a state of being irradiated with light from a metal halide lamp as a light source at an illuminance of 900 W/m². Then, by the method described in ISO13837, TTS after a test for hot weather fastness was calculated, and a value of change in TTS (ΔTTS) before and after the test for hot weather fastness was calculated. The smaller the value of ΔTTS, the better the hot weather fastness.

TABLE 8

| | Metal flat plate particle | | |
|---|---|---|---|
| | metal flat plate | metal flat plate | |
| | particle-containing | particle-containing | |
| | layer 2 | layer 1 | Δ TTS (%) |
| Example 8 | Silver nanodisk | Silver nanodisk | 8.3 |
| | dispersion liquid | dispersion liquid | |
| | a2 | b2 | |
| Example 9 | Silver nanodisk | Silver nanodisk | 1.7 |
| | dispersion liquid | dispersion liquid | |
| | a2A′ | b2A′ | |
| Example 10 | Silver nanodisk | Silver nanodisk | 0.8 |
| | dispersion liquid | dispersion liquid | |
| | a2A″ | b2A″ | |

The change in TTS (ΔTTS) before and after the test for hot weather fastness was smaller in Example 10 than in Example 8. Example 10 has a suitable constitution that results in a small change in TTS by being irradiated with sunlight in a case where Example 10 is used, for example, for automobiles.

The entire disclosure of JP2017-129437 filed on Jun. 30, 2017 is incorporated into the present specification by reference.

All the documents, patent applications, and technical standards described in the present specification are incorporated into the present specification by reference as if each of the documents, the patent applications, and the technical standards is specifically and independently described and incorporated into the present specification by reference.

### EXPLANATION OF REFERENCES

10: heat ray-screening material, 12: metal flat plate particle-containing layer 1, 14: dielectric layer, 16: metal flat plate particle-containing layer 2, 18: ultraviolet absorbing layer, 20: interlayer, 22: glass, 24: substrate, 30: interlayer for laminated glass, 35A, 35B: silver nanodisk, 50: laminated glass, T: thickness, D: equivalent circular diameter, L: solar radiation incoming direction

What is claimed is:

1. A heat ray-screening material comprising at least:
a metal flat plate particle-containing layer A containing metal flat plate particles a having an aspect ratio equal to or higher than 10 and equal to or lower than 20; and
a metal flat plate particle-containing layer B containing metal flat plate particles b having an aspect ratio higher than 20 and equal to or lower than 60.

2. The heat ray-screening material according to claim 1, further comprising:
at least one transparent dielectric layer between the metal flat plate particle-containing layer A and the metal flat plate particle-containing layer B.

3. The heat ray-screening material according to claim 2,
wherein an optical thickness nd of the dielectric layer satisfies Formula 1 for a wavelength λ1 at which a reflectance is minimized,
{(2m+1)×(λ1/4)}−{(λ1/4)×0.20}<nd<{(2m+1)×(λ1/4)}+{(λ1/4)×0.20} Formula (1)
m represents an integer equal to or greater than 0, λ1 represents a wavelength at which a reflectance is minimized, n represents a refractive index of the dielectric layer, d represents a thickness of the dielectric layer, and the unit of λ1 and d is nm.

4. The heat ray-screening material according to claim 3,
wherein m in Formula 1 is 0 or 1.

5. The heat ray-screening material according to claim 4,
wherein in a case where m is 0, the metal flat plate particle-containing layer B is disposed to be closer to a solar radiation incoming direction than the metal flat plate particle-containing layer A is, and
in a case where m is 1, the metal flat plate particle-containing layer A is disposed to be closer to the solar radiation incoming direction than the metal flat plate particle-containing layer B is.

6. The heat ray-screening material according to claim 1,
wherein each of the metal flat plate particles a and the metal flat plate particles b contains at least silver.

7. The heat ray-screening material according to claim 1, further comprising:
an ultraviolet absorbing layer.

8. The heat ray-screening material according to claim 7,
wherein the ultraviolet absorbing layer is closer to the solar radiation incoming direction than the metal flat plate particle-containing layer A and the metal flat plate particle-containing layer B are.

9. The heat ray-screening material according to claim 1,
wherein the aspect ratio of the metal flat plate particles b is equal to or higher than 30 and equal to or lower than 60.

10. The heat ray-screening material according to claim 1,
wherein a value of the aspect ratio of the metal flat plate particles b/the aspect ratio of the metal flat plate particles a is equal to or higher than 2 and equal to or lower than 6.

11. An interlayer for laminated glass comprising:
the heat ray-screening material according to claim 1.

12. Laminated glass comprising:
the interlayer for laminated glass according to claim 11; and
at least two sheets of glass plates,
wherein the interlayer for laminated glass is between two sheets of the glass plates.

13. A heat ray-screening material comprising at least:
a metal flat plate particle-containing layer A containing metal flat plate particles a; and
a metal flat plate particle-containing layer B containing metal flat plate particles b,
wherein an absolute value of a difference between a maximum reflection wavelength of the metal flat plate particle-containing layer A and a maximum reflection wavelength of the metal flat plate particle-containing layer B is equal to or higher than 220 nm.

14. The heat ray-screening material according to claim 1,
wherein an average thickness of the metal flat plate particles a is 20 nm or less.

15. The heat ray-screening material according to claim 1,
wherein an average thickness of the metal flat plate particles b is 20 nm or less.

16. The heat ray-screening material according to claim 1,
wherein both of the average thickness of the metal flat plate particles a and the average thickness of the metal flat plate particles b are 20 nm or less.
